(19) United States
(12) Patent Application Publication
(10) Pub. No.: US 2012/0011339 A1
(43) Pub. Date: Jan. 12, 2012

(54) STORAGE CONTROL APPARATUS AND CONTROL METHOD FOR VIRTUAL LOGICAL VOLUME

(75) Inventors: Akihiro Mori, Odawara (JP); Kazue Jindo, Odawara (JP); Takumi Sano, Odawara (JP); Junichi Muto, Odawara (JP); Isamu Kurokawa, Odawara (JP)

(73) Assignee: HITACHI, LTD., Tokyo (JP)

(21) Appl. No.: 12/738,789

(22) PCT Filed: Apr. 5, 2010
(86) PCT No.: PCT/JP2010/002486

§ 371 Date: Apr. 19, 2010

(51) Int. Cl. G06F 12/02

(52) U.S. Cl. 711/171; 711/E12.002

(57) ABSTRACT

A controller 2 uses a virtual logical volume 3 having an expandable volume size to perform either a remote copy or an internal copy without suspending access from a host. The virtual logical volume 3 is able to expand a volume size in units of a cylinder group 6 that have a size equivalent to 25 pages. Information for managing a copy is stored in a control area 6B inside the cylinder group 6. This enables storing of copy management information in accordance with the expanded size of the virtual logical volume.

### TECHNICAL FIELD

This invention relates to a storage control apparatus and a control method for a virtual logical volume.

### BACKGROUND ART

The amount of data being utilized by users is increasing everyday, and none of the capacities of the volume sizes being set to meet current data amounts will be large enough. By contrast, setting volume sizes in excess of the size required at present in anticipation of future increases in data amounts results in lots of nonessential, non-urgent disk drives and increases costs. Accordingly, technology that provides a virtual logical volume, and allocates a real storage area to this virtual logical volume in accordance with actual usage has been proposed (Patent Literature 1 and Patent Literature 2).

In addition, a storage control apparatus enhances data security by storing identical data in respectively different logical volumes. The one logical volume becomes the primary volume, and the other logical volume becomes the secondary volume.

The storage content of the primary volume is either regularly or irregularly copied to the secondary volume. When the primary volume is updated subsequent to the storage content of the primary volume and the storage content of the secondary volume having been made identical, a difference occurs between the primary volume and the secondary volume.

The storage control apparatus manages the location in which the difference occurred and the difference data, transfers the difference data from the primary volume and stores same in the secondary volume. In accordance with this, storage content of the primary volume and the storage content of the secondary volume are made identical once again (Patent Literature 3).

### [Citation List]

### [Patent Literature]

### [PTL 1]

U.S. Pat. No. 6,823,442

### [PTL 2]

Japanese Patent Application Laid-open Publication No. 2009-251970

### [PTL 3]

Japanese Patent Application Laid-open Publication No. 2005-301590

### SUMMARY OF INVENTION

### [Technical Problem]

In the prior art, difference management information for managing a difference that occurs between the primary volume and the secondary volume is stored inside a shared memory of the storage control apparatus. The size of the difference management information is fixed. When managing a copy of a virtual logical volume with an expandable volume size, there is the fear that the virtual logical volume size will exceed the size capable of being managed in accordance with the difference management information.

As one solution for this, setting the size of the difference management information to meet the maximum size of the expandable virtual logical volume is conceivable. However, configuring the difference management information like this generates an unused idle area inside the difference management information in a case where the virtual logical volume is not expanded to the maximum size. Since the storage control apparatus can manage large numbers of logical volumes and copy-pairs, wastefulness generated in one difference management information results in a considerable amount of waste for the storage control apparatus as a whole. Additionally, the maximum expandable size is not a constant value, and is likely to change in the future. Therefore, a method that sets the size of the difference management information to coincide the maximum size of the virtual logical volume will have low expandability.

Accordingly, an object of the present invention is to provide a storage control apparatus and a virtual logical volume control method that make it possible to manage control information in accordance with the expansion size of a virtually created logical volume. Another object of the present invention is to provide a storage control apparatus and a virtual logical volume control method that make it possible to store control information in a prescribed control area in accordance with the expansion size of the virtually created logical volume. Yet other objects of the present invention should become clear from the description of the embodiment, which will be explained below.

### [Solution to Problem]

A storage control apparatus according to a first aspect of the present invention for solving the above-mentioned problems comprises: a virtual logical volume, which is a virtually created logical volume, and which is accessible from a host computer; spool which has a real storage area that is allocated to the virtual logical volume; and a controller, which controls the allocation of the real storage area to the virtual logical volume, and which relates the real storage area inside the pool to the virtual logical volume in units of a first real storage area that has a prescribed first size, and selects a second real storage area that has a prescribed second size from the first real storage area related to the virtual logical volume and allocates same to the virtual logical volume in accordance with a write request from the host computer, and the first size is set to an integral multiple of the second size, and control information related to a first real storage area concerned is stored in this first real storage area.

In a second aspect according to the first aspect, the virtual logical volume is coupled to the host computer and to another storage control apparatus via a communication network, the host computer is configured as a mainframe, the controller has: an allocation controller for allocating the first real storage area and the second real storage area to the virtual logical volume; a correspondence managing unit for managing a corresponding relationship between the virtual logical volume, the first real storage area, and the second real storage area; an access request processor for processing an access request from the host computer to the virtual logical volume based on the corresponding relationship managed by the correspondence managing unit; and a copy controller, which creates a copy-pair between the virtual logical volume and another logical volume inside the storage control apparatus and copies data between the virtual logical volume and the other logical volume, the first real storage area that is allocated to the virtual logical volume has a user area, which the host computer is able to access via the access request processor, and a control area for storing the control information to be used by the copy controller, the allocation controller expands a volume size of the virtual logical volume in units of the first real storage area without suspending access to the virtual logical volume from the host computer, the controller provides only the user area of the first real storage area allocated to the virtual logical volume to the host computer, the controller, in a case where prescribed data inside the user area is accessed by the host computer, specifies the control information corresponding to the prescribed data based on an access-destination address of the host computer and updates the specified control information, and the copy controller copies difference data generated in the user area by transferring this difference data to the other logical volume based on the control information stored in the control area.

In a third aspect according to the first aspect, the control information is stored either at the start or the end of the first real storage area, another area of the first real storage area besides the area in which the control information is stored is the user area that is able to be used by the host computer, and, in addition, the controller provides the host computer with only the user area, enabling access thereto.

In a fourth aspect according to the third aspect, the controller, in a case where prescribed data of the user area is accessed by the host computer, specifies a location of the control information corresponding to the prescribed data based on the access-destination address of the host computer.

In a fifth aspect according to the third aspect, the virtual logical volume forms a copy-pair with the other logical volume, and the control information includes copy management information for managing the copy-pair.

In a sixth aspect according to the fifth aspect, the copy management information includes information showing the type of the copy-pair.

In a seventh aspect according to the fifth aspect, the copy management information includes: information for managing a difference between storage content of the virtual logical volume and storage content of the other logical volume; internal copy information for showing that the other logical volume and the virtual logical volume are disposed in the same storage control apparatus; and external copy information for showing that the other logical volume and the virtual logical volume are disposed in different storage control apparatuses.

In an eighth aspect according to the fifth aspect, the control information includes a reserved bit prepared for future functional expansion.

In a ninth aspect according to the first aspect, the virtual logical volume is configured from a real logical volume and the second real storage area that is allocated from the pool.

In a tenth aspect, the virtual logical volume is configured only from the second real storage area that is allocated from the pool.

In an eleventh aspect according to the first aspect, the real storage area inside the pool has a RAID configuration.

In a twelfth aspect according to the first aspect, the host computer is configured as a mainframe.

A virtual logical volume control method according to a thirteenth aspect is a method for controlling a virtual logical volume, which is a virtually created logical volume, the method comprising: in a case where volume size of the virtual logical volume is expanded, allocating the real storage area that is managed in the pool to the virtual logical volume in units of a first real storage area that has a prescribed first size without suspending access from the host computer; selecting a second real storage area that has a second size from the first real storage area allocated to the virtual logical volume and allocating same to the virtual logical volume in accordance with a write request from the host computer; setting the first size to an integral multiple of the second size; storing control information related to the first real storage area in this first real storage area; and providing the host computer with an area, which excludes the control information of the first real storage area, as a user area.

At least a portion of the present invention may be made as a computer program. This computer system can be distributed via either a communication medium or a storage medium. In addition, other combinations besides the combinations of the above-mentioned aspects are also included within the scope of the present invention.

### BRIEF DESCRIPTION OF DRAWINGS

[FIG. 1]

FIG. 1 is a diagram showing an overview of the embodiment.

[FIG. 2]

FIG. 2 is a diagram showing the overall configuration of a computer system.

[FIG. 3]

FIG. 3 is a block diagram of a storage control apparatus.

[FIG. 4]

FIG. 4 is a schematic diagram showing the functions of the storage control apparatus.

[FIG. 5]

FIG. 5 is a diagram showing the configuration of a virtual logical volume.

[FIG. 6]

FIG. 6 is a diagram showing another configuration of the virtual logical volume.

[FIG. 7]

FIG. 7 is a diagram showing the relationship between a page, a cylinder, and a track.

[FIG. 8]

FIG. 8 is a diagram showing a user area recognized by the host.

[FIG. 9]

FIG. 9 is a diagram showing the configuration of a control area.

[FIG. 10]

FIG. 10 is a diagram showing the configuration of control information.

[FIG. 11]

FIG. 11 is a diagram showing the configuration of other information that is included in the control area.

[FIG. 12]

FIG. 12 is a flowchart showing access processing.

[FIG. 13]

FIG. 13 is a continuation of the flowchart of FIG. 12.

[FIG. 14]

FIG. 14 is another continuation of the flowchart of FIG. 12.

[FIG. 15]

FIG. 15 is a flowchart showing page allocation processing.

[FIG. 16]

FIG. 16 is a diagram showing the status transitions of the copy-pair.

[FIG. 17]

FIG. 17 is a flowchart showing update processing for control information.

[FIG. 18]

FIG. 18 is a continuation of the flowchart of FIG. 17.

[FIG. 19]

FIG. 19 is a flowchart showing the processing for referencing the control information.

[FIG. 20]

FIG. 20 is a continuation of the flowchart of FIG. 19.

[FIG. 21]

FIG. 21 is a diagram showing another configuration of the control information.

### DESCRIPTION OF EMBODIMENTS

The embodiment of the present invention will be explained below based on the drawings. The present invention, as will be described below, expands the size of a virtual logical volume 3 in prescribed first size units. A first size real storage area (a cylinder group) 6 comprises a user area 6A, which is used by a host computer (hereinafter, the host) 7, and a control area 6B for storing control information. The installation location and size of the control area 6B inside the first real storage area 6 remain the same even when the size of the virtual logical volume 3 is expanded. Therefore, it is possible to determine the control information that corresponds to the data to be accessed by the host 7 by performing computations based on the access-destination address of the host 7 and the structure of the first real storage area 6.

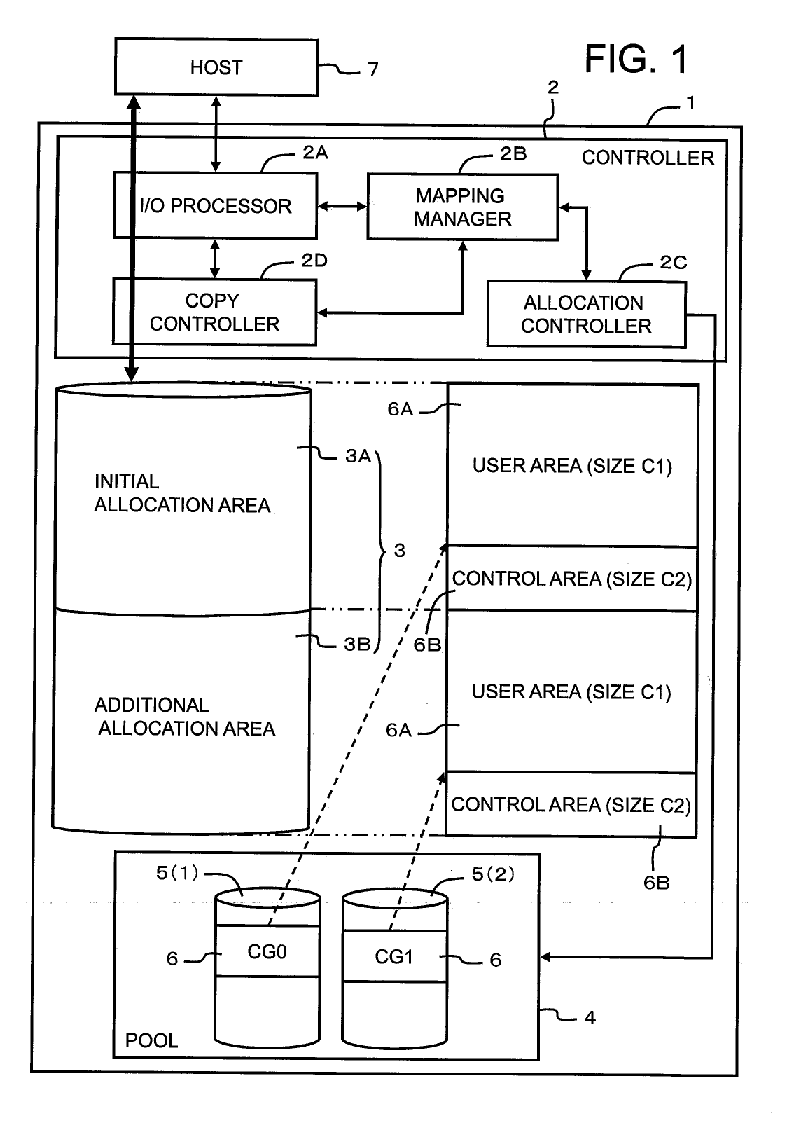

FIG. 1 is a schematic diagram showing the overall configuration of this embodiment. FIG. 1 is described to the extent necessary to understand and implement the present invention. The scope of the present invention is not limited to the configuration described in FIG. 1. Characteristic features that are not described in FIG. 1 will become clear in the aspects described hereinbelow.

A storage control apparatus 1 is communicably coupled to the host 7. The host 7 is configured as either a server computer, which is known as a so-called open system computer, or a mainframe computer.

In a case where the host 7 is a host computer, for example, data communications are carried out in accordance with a communication protocol such as FICON (Fibre Connection: registered trademark), ESCON (Enterprise System Connection: registered trademark), ACONARC (Advanced Connection Architecture: registered trademark), or FIBARC (Fibre Connection Architecture: registered trademark). In a case where the host 7 is a server computer, for example, data communications are carried out in accordance with a communication protocol such as FCP (Fibre Channel Protocol) or iSCSI (internet Small Computer System Interface).

The storage control apparatus 1 may be configured so as to be able to be coupled to both a mainframe and an open system server. However, in this embodiment and in the aspects described below, the explanations will focus on a case where the host 7 is a mainframe.

The storage control apparatus 1 is coupled to the host 7 via a communication network. The storage control apparatus 1, for example, comprises a controller 2, a pool 4, storage devices 5 (1) and 5 (2), and a virtual logical volume 3.

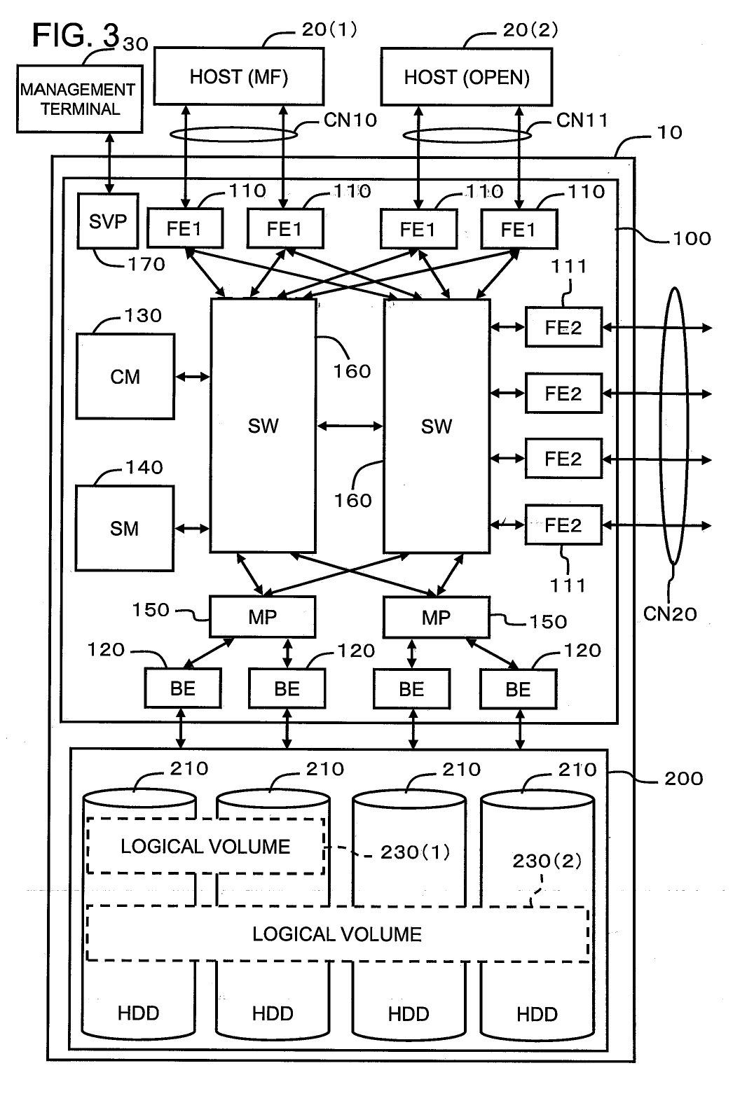

The controller 2 controls the operation of the storage control apparatus 1. The controller 2, as will become clear from the aspects described hereinbelow, comprises a microprocessor 150, a cache memory 130, a shared memory 140, and communication interface circuits 110, 111, and 120 (Refer to FIG. 3 for all of these). The controller 2 realizes the respective processes described hereinbelow by reading in and executing prescribed computer programs.

The controller 2 comprises an I/O (Input/Output) processor 2A as the “access request processor”, a mapping managing unit 2B as the “correspondence managing unit”, an allocation controller 2C, and a copy controller 2D.

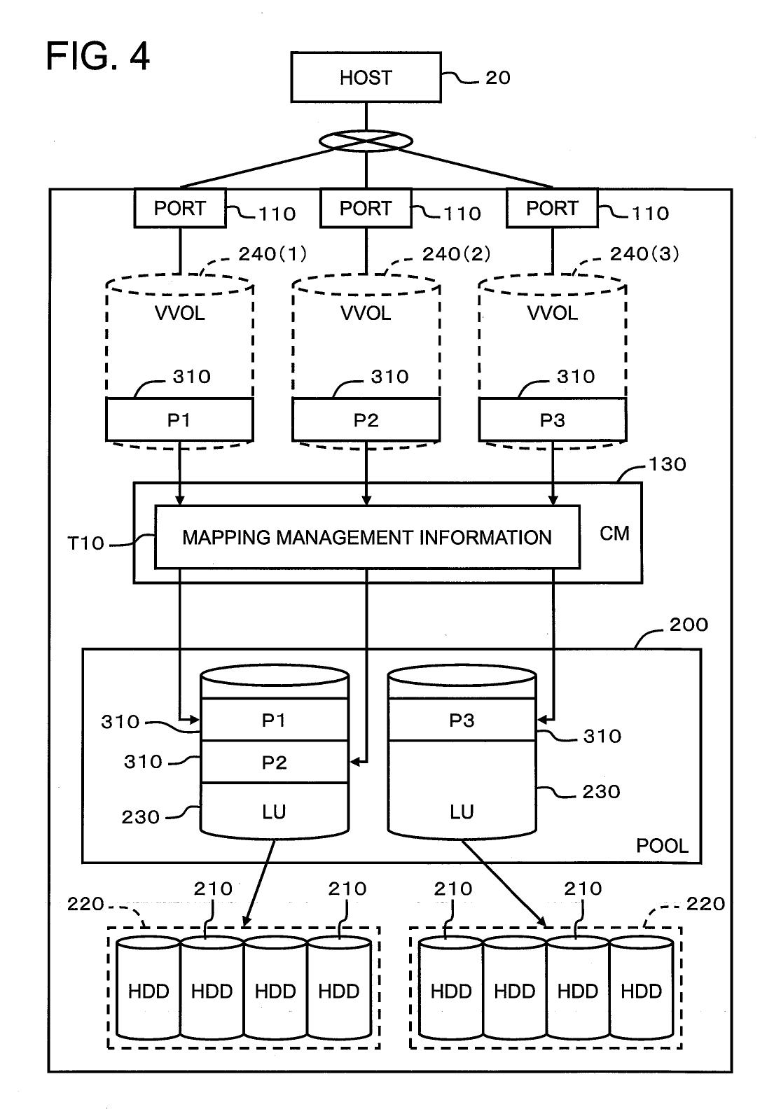

The I/O processor 2A accesses a page 310 (refer to FIG. 4) as the “second real storage area” that configures the virtual logical volume 3 in accordance with either a read request or a write request from the host 7. The I/O processor 2A writes data (write data) received from the host 7 to a page that has been allocated to the virtual logical volume 3. Additionally, the I/O processor 2A reads data requested from the host 7 from a page, and sends this data to the host 7.

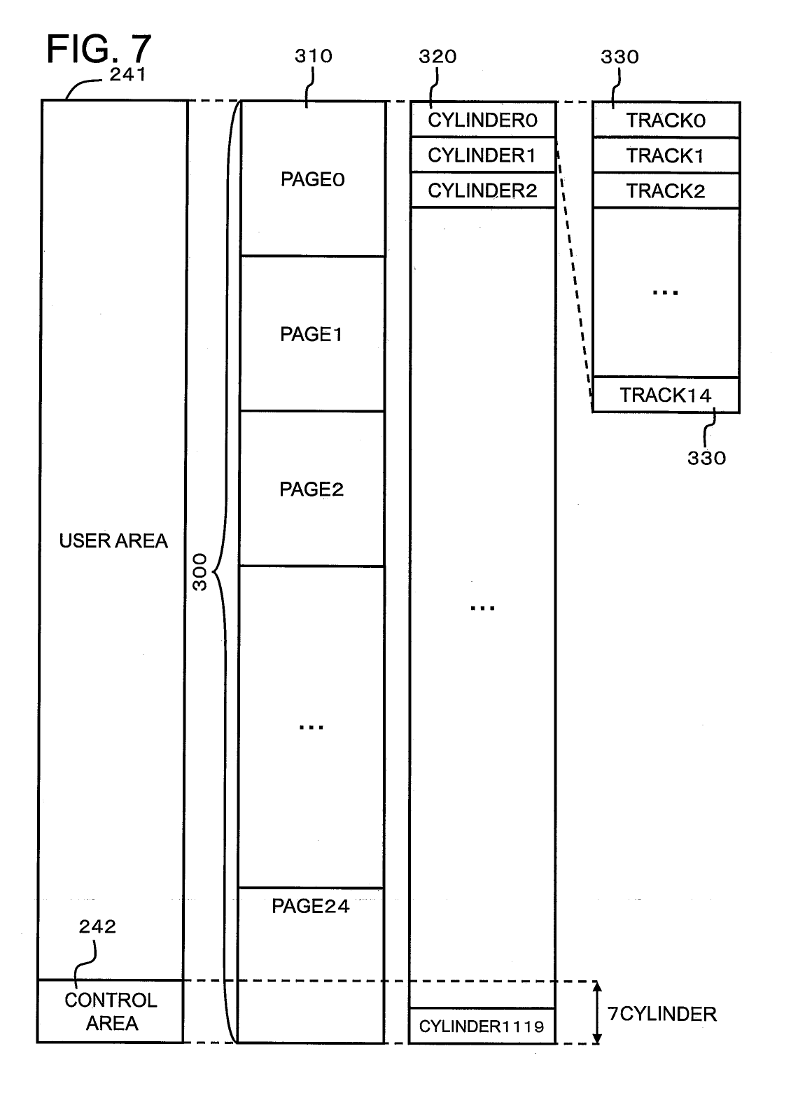

The pages allocated to the virtual logical volume 3 are configured from a plurality of tracks as will be explained using FIG. 7. The I/O processor 2A reads data in track units and writes data in track units.

The mapping managing unit 2B correspondingly manages an address of the virtual logical volume 3 and an address of the real storage area allocated to the virtual logical volume 3.

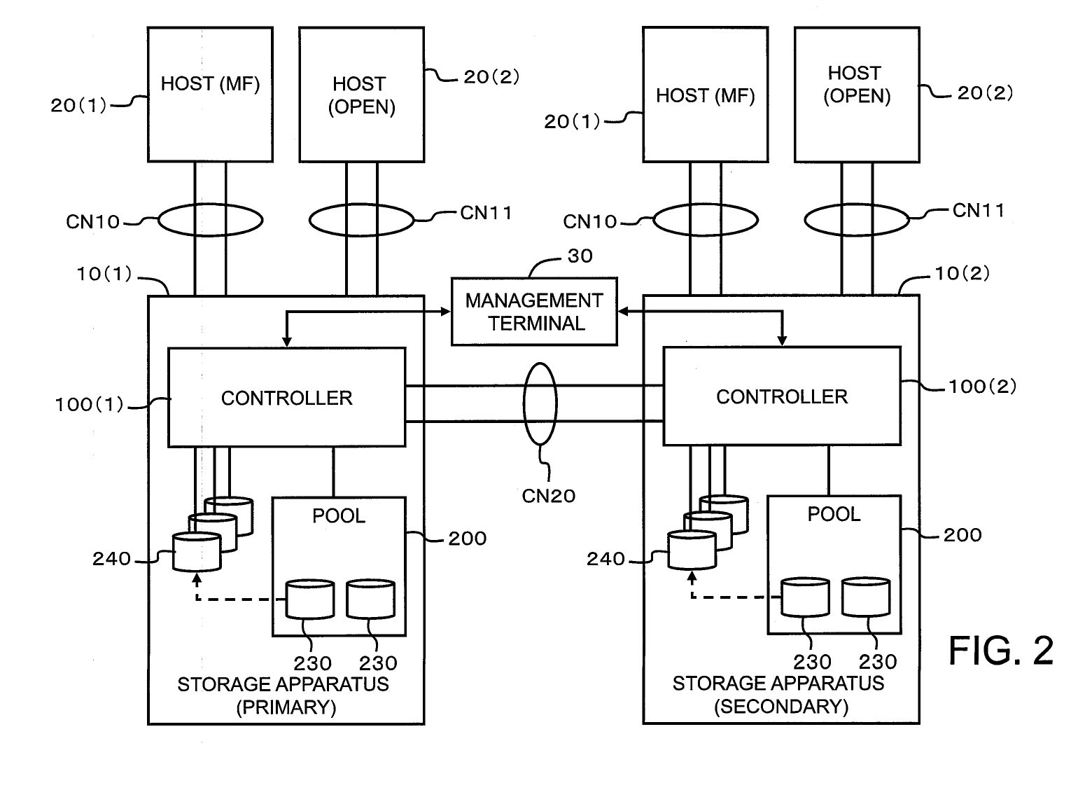

The allocation controller 2C allocates a cylinder group 6 as the “first real storage area” to the virtual logical volume 3 in accordance with either a request from the host 7 or an instruction from a management terminal 30 (refer to FIG. 2).

In addition, the allocation controller 2C allocates an unused page inside the cylinder group 6 to the virtual logical volume 3 in accordance with a write request from the host 7. The mapping managing unit 2B stores the result of the allocation of the real storage area (the cylinder group and the page) to the virtual logical volume 3 by the allocation controller 2C.

The copy controller 2D controls a copy-pair that is formed between the virtual logical volume 3 and another logical volume not shown in the drawing. The other logical volume may be managed by the same storage control apparatus 1 as the virtual logical volume 3, or may be managed by a storage control apparatus that is different from the storage control apparatus 1 that manages the virtual logical volume 3. A copy to another logical volume that is managed by the same storage control apparatus is called an internal copy. A copy to another logical volume that is managed by another storage control apparatus is called an external copy. The copy controller 2D controls the copy between the virtual logical volume 3 and the other logical volume in accordance with the control information stored in the control area 6B.

The pool 4 will be explained before explaining the virtual logical volume 3. The pool 4 manages the real storage area that is allocatable to the virtual logical volume. The pool 4 comprises a plurality of storage devices 5 (1) and 5 (2). With the exception of a case in which a particular distinction is made between them, these storage devices will be called the storage device 5.

As the storage device 5, for example, various devices that are capable of reading and writing data can be used, such as a hard disk device, a semiconductor memory device, an optical disk device, a magneto-optical disk device, a magnetic tape device, and a flexible disk device.

In a case where a hard disk device is utilized as the storage device 5, for example, a FC (Fibre Channel) disk, a SCSI (Small Computer System Interface) disk, a SATA disk, an ATA (AT Attachment) disk, and a SAS (Serial Attached SCSI) disk may be used. It is also possible, for example, to use a variety of storage devices 5, such as a flash memory, a FeRAM (Ferroelectric Random Access Memory), a MRAM (Magnetoresistive Random Access Memory), an Ovonic Unified Memory, and a RRAM (Resistance RAM). For example, the configuration may also be such that different types of storage devices 5 like a flash memory device and a hard disk drive are intermixed.

The cylinder group and page that serve as the real storage area are created by making the physical storage area of the plurality of storage devices 5 redundant based on RAID. That is, the real storage area allocated to the virtual logical volume 3 comprises a redundant configuration, making it fault tolerant.

The cylinder group 6 is for grouping together a prescribed number of cylinders. For example, 1120 can be given as the prescribed number. One cylinder is configured from 15 tracks. The size of one track, for example, is 58 kB. One cylinder group 6 comprises 16800 tracks (1120×15=16800).

The cylinder group 6 comprises a plurality of pages. The size of one page, for example, is 38 MB. Dividing the page size by the track size works out to 672 tracks (38 MB is substantially equal to 38976 kB. 38976/58=672). Therefore, one cylinder group 6 comprises 25 pages (16800/672=25). In other words, the cylinder group 6 is set at an integral multiple (25 times) of pages, which is the smallest allocation unit to the virtual logical volume 3.

The configuration of the virtual logical volume 3 will be explained. The virtual logical volume 3 may comprise an initial allocation area 3A, which is allocated from the start, and an additional allocation area 3B, which is allocated additionally. The size of the initial allocation area 3A and the size of the additional allocation area 3B are the same as the size of the cylinder group 6. That is, the volume size of the virtual logical volume 3 is expanded in cylinder group 5 size units. A new cylinder group 6 can be allocated to the virtual logical volume 3 without suspending access to the virtual logical volume 3 from the host 7.

The cylinder group 6, which is the allocation unit, comprises a user area 6A and a control area 6B. The user area 6A is used by the host 7 and stores user data. The control area 6B is for storing control information. In a case where the size of the cylinder group 6 is 1120 cylinders, the size of the user area 6A is 1113 cylinders and the size of the control area 6B is seven cylinders.

The control area 6B is disposed at the end of the user area 6A. The control area 6B stores control information for the user area 6A that corresponds to this control area 6B. The user area 6A that corresponds to the control area 6B is the user area 6A that belongs to the same cylinder group 6 as the cylinder group 6 of the control group 6B. For example, copy management information, which is used by the copy controller 2D, is stored in the control area 6B. The copy management information comprises difference management information for identifying the location (the track) where a difference has occurred. That is, the control information for the user areas 6A included in the respective cylinder groups 6 is managed inside the respective cylinder groups 6 allocated to the virtual logical volume 3.

The cylinder group 6 (CG0), which has been allocated to the initial allocation area 3A, comprises one user area 6A and one control area 6B. Similarly, the other cylinder group 6 (CG1), which is allocated to the additional allocation area 3B that follows the initial allocation area 3A, comprises another one user area 6A and another one control area 6B. That is, each cylinder group 6, which is the virtual logical volume allocation unit, comprises the same structure.

The host 7 recognizes only the user area 6A of the virtual logical volume 3. In the example shown in the drawing, the host 7 sees the virtual logical volume 3 as a single logical volume comprising a volume size that is twice the size of one user area 6A (the size of 1113 cylinders).

This embodiment expands the volume size of the virtual logical volume 3 like this using the cylinder group 6, which is a size that is an integral multiple of the page size, as the basic unit. In addition, this embodiment disposes the user area 6A and the control area 6B in the cylinder group 6, and stores the control information in the control area 6B. Therefore, it is possible to manage the control information for each user area 6A even in a case where the virtual logical volume 3 has been expanded to the maximum size. For this reason, the generation of idle areas in the control area can be prevented more than in a case where the size of the control area is created to match the maximum expandable size of the virtual logical volume 3. Additionally, providing a control area 6B that is fixed at a second size for each user area 6A that is fixed at a first size makes it possible to identify the control information corresponding to data inside the user area on the basis of a simple computational expression. This embodiment will be explained in detail below.

### EXAMPLE 1

FIG. 2 shows the overall configuration of a computer system comprising storage control apparatuses 10 (1) and 10 (2) according to this example. First, the corresponding relationship with FIG. 1 will be explained. Either storage control apparatus 10 (1) or 10 (2) corresponds to the storage control apparatus 1 of FIG. 1, either host 20 (1) or 20 (2) corresponds to the host 7 of FIG. 1, and either controller 100 (1) or 100 (2) corresponds to the controller 2 of FIG. 1. The pool 200 corresponds to the pool 4 of FIG. 1, the virtual logical volume 240 corresponds to the virtual logical volume 3 of FIG. 1, and the logical volume 230 corresponds to either storage 5 (1) or 5 (2) of FIG. 1.

The computer system shown in FIG. 2, for example, comprises a plurality of storage control apparatuses 10 (1) and 10(2), a plurality of hosts 20 (1) and 20 (2), at least one management terminal 30, and communication networks CN10, CN11 and CN20.

Host 20 (1) and host 20 (2) are both coupled to the respective storage control apparatuses 10 (1) and 10 (2). The host 20 (1), for example, is a mainframe computer. The host 20 (2), for example, is a server computer. The host 20 (1) and the storage control apparatuses 10 (1) and 10 (2), for example, are coupled via a communication network CN10 like a FC-SAN (Fibre Channel-Storage Area Network). The host 20 (2) and the storage control apparatuses 10 (1) and 10 (2), for example, are coupled via a communication network CN11 like an IP-SAN (Internet Protocol_SAN). When there is no need to make a distinction hereinbelow, hosts 20 (1) and 20 (2) will be called host 20.

The communication network CN20 is an inter-apparatus communication network for directly coupling the one storage control apparatus 10 (1) with the other storage control apparatus 10 (2). The communication network CN20, for example, is configured as a LAN (Local Area Network). The communication network configuration shown in the drawing is simply an example. For example, a configuration that uses a single communication network to carry out communications between the hosts 20 (1) and 20 (1) and the storage control apparatuses 10 (1) and 10 (2), and communications between the storage control apparatus 10 (1) and the storage control apparatus 10 (2) may also be used.

The management terminal 30 gives instructions to the storage control apparatuses 10 (1) and 10 (2), and collects information from the storage control apparatuses 10 (1) and 10 (2). In FIG. 2, it appears like the two storage control apparatuses 10 (1) and 10 (2) are managed by one management terminal 30, but actually a management terminal 30 is provided for each storage control apparatus.

The storage control apparatus 10 (1) comprises a controller 100 (1), a pool 200, a virtual logical volume 240, and a logical volume 230. Similarly, the other storage control apparatus 10 (2) comprises a controller 100 (2), another virtual logical volume 240, and another logical volume 230.

The one storage control apparatus 10 (1) is either the copy-source storage control apparatus or the primary storage control apparatus. The other storage control apparatus 10 (2) is either the copy-destination storage control apparatus or the secondary storage control apparatus. The copy-source storage control apparatus 10 (1) and the copy-destination storage control apparatus 10 (2) may be disposed in physically separated locations, or may be disposed inside the same building. When there is no need to distinguish between the storage control apparatus 10 (1) and the storage control apparatus 10 (2) below, these apparatuses will be called the storage control apparatus 10. Similarly, the controllers 100 (1) and 100 (2) may be called the controller 100.

FIG. 3 is a block diagram showing the configuration of the storage control apparatus 10. The controller 100, for example, comprises a plurality of communication interface circuits 110, 111, 120, at least one cache memory 130, at least one shared memory 140, a plurality of microprocessors 150, a plurality of switches 160, and a service processor 170.

A first communication interface circuit 110 (FE1 in the drawing) is a communication control circuit for communicating with the host 20. A second communication interface circuit 120 (FE2 in the drawing) is a communication control circuit for communicating with a storage device 210 that configures the logical volume 230. A third communication interface circuit 111 (BE in the drawing) is a communication control circuit for communicating with the other storage control apparatus 10. The third communication interface circuit 111 may also be called the remote-copy communication interface circuit. FE is the abbreviation for front-end and BE is the abbreviation for back-end. Furthermore, although omitted from FIG. 3, the third communication interface circuit 120 is coupled to the switches 160.

The cache memory 130 temporarily stores either data received from the host 20 or data read out from the logical volume 230.

The shared memory 140 stores various types of management information and control information needed for controlling the storage control apparatus 10. Information for controlling a virtual logical volume 240 copy is not included in the control information stored in the shared memory 140. Information for controlling a copy is stored in the real storage area (either all or a portion of the logical volume) that is allocated to the virtual logical volume 240.

The microprocessor (MP in the drawing) 150 controls the operation of the controller 100 by reading in and executing a prescribed computer program. The switch (SW in the drawing) 160 is coupled to the communication interface circuits 110, 111, 120, the cache memory 130, the shared memory 140, and the microprocessor 150.

The service processor 170 is coupled to the management terminal 30 via a communication network such as a LAN. The service processor 170 changes a setting of the storage control apparatus 10 in accordance with an instruction from the management terminal 30. In addition, the service processor 170 collects information of the devices inside the storage control apparatus 10 and sends this information to the management terminal 30 in accordance with an instruction from the management terminal 30.

The pool 200 comprises a plurality of logical volumes 230 that provide the real storage area. The logical volume 230 is created using a plurality of storage devices 210 that provide the physical storage area. In the example shown in the drawing, the one logical volume 230 (1) comprises redundancy on the basis of RAID 1. The other one logical volume 230 (2), for example, comprises redundancy using the parity of RAID 5 or RAID 6 and so forth.

As the storage device 210, for example, a hard disk drive, a semiconductor memory drive, a flash memory device or other such rewritable types of devices may be used. A group of physical storage areas of a plurality of storage devices 210 that has been grouped together on the basis of RAID is a RAID group 220 (refer to FIG. 4).

FIG. 4 schematically shows the relationship between the virtual logical volume 240 and the logical volume 230 inside the pool 200. The virtual logical volume (VVOL in the drawing) 240 is coupled to the host 20 via a communication port of the first communication interface circuit 110.

A plurality of logical volumes 230 are accommodated in the pool 200. The logical volumes 230 provide the virtual logical volume 240 with a page 310 as the second real storage area in accordance with a write request from the host 20.

The mapping management information T10, which is stored in the cache memory 130, is for managing where the pages of the logical volume 230 are allocated, i.e. to which virtual logical volumes 240 and to what locations in those virtual logical volumes 240 they are allocated. That is, the mapping management information T10 manages the corresponding relationship between the address space of the virtual logical volume 240 and the address space of the logical volume 230 in page-size units.

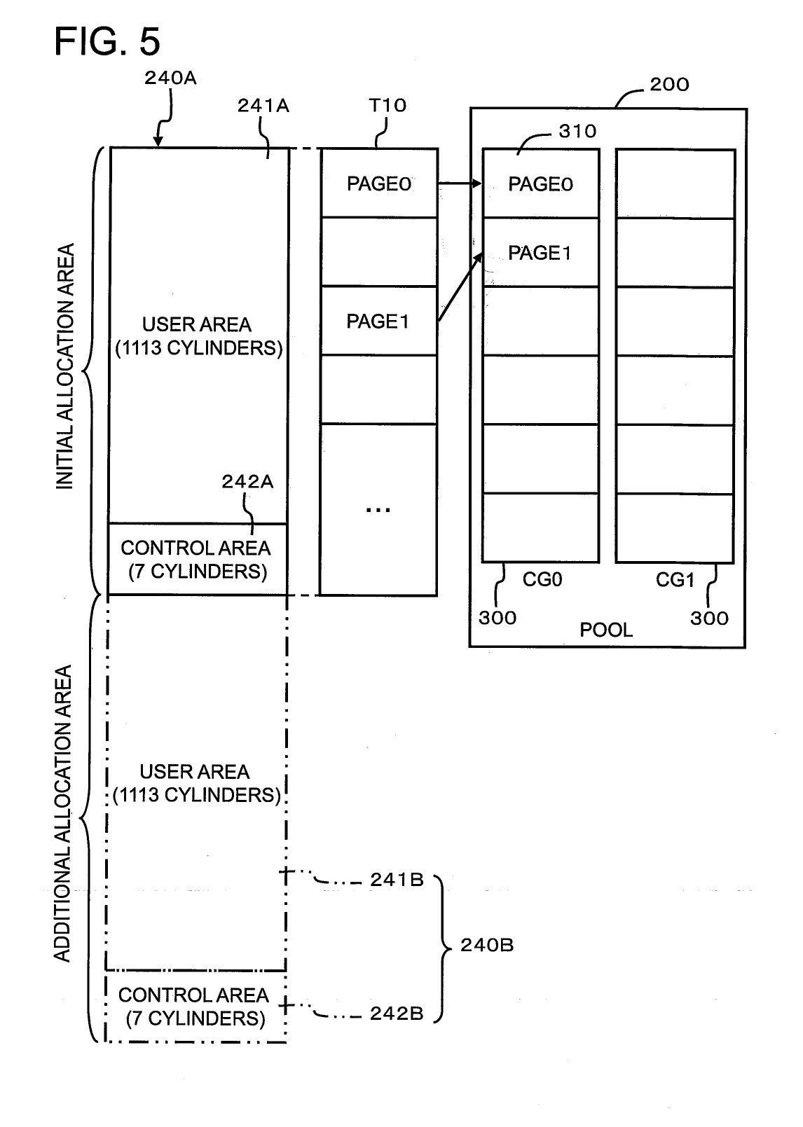

FIG. 5 shows how a page 310 managed inside the pool 200 is allocated to the virtual logical volume 240. The virtual logical volume 240 comprises an initial allocation area 240A. In addition, it is also possible to carry out an allocation by adding a new area 240B in the virtual logical volume 240. In the example of FIG. 5, only the initial allocation area 240A has been allocated to the virtual logical volume 240.

The allocation areas 240A and 240B are both the same size and comprise the same configuration. The initial allocation area 240A comprises a user area 241A and a control area 242A. The size of the initial allocation area 240A is equivalent to the size of 1120 cylinders (size of 240A=size of cylinder×1120). The size of the user area 241A is equivalent to the size of 1113 cylinders (size of 241A=size of cylinder×1113). The size of the control area 242A is equivalent to the size of seven cylinders (size of 242A=size of cylinder×7). Furthermore, in the drawing, a “size that is equivalent to the size of n cylinders (=size of cylinder×n)” is expressed as “n cylinders”. In the previous example, the size of the user area 241A is 1113 cylinders, and the size of the control area 242A is seven cylinders.

The additional allocation area 240B also comprises a user area 241B and a control area 242B. The size of the additional allocation area 240B is the size of 1120 cylinders. The size of the user area 241B is the size of 1113 cylinders. The size of the control area 242B is the size of seven cylinders.

The mapping management information T10, as described hereinabove, manages the corresponding relationship between the address space of the virtual logical volume 240 and the pages 310 managed inside the pool 200. The volume size of the virtual logical volume 240 is expandable using cylinder group 300 size units as the first size. The cylinder group 300 is created by grouping together a plurality of real storage area cylinders.

As described above, the volume size of the virtual logical volume 240 is capable of being expanded in cylinder group 300 size units. The real storage area is allocated to the virtual logical volume 240 in units of the pages included in the cylinder group 300.

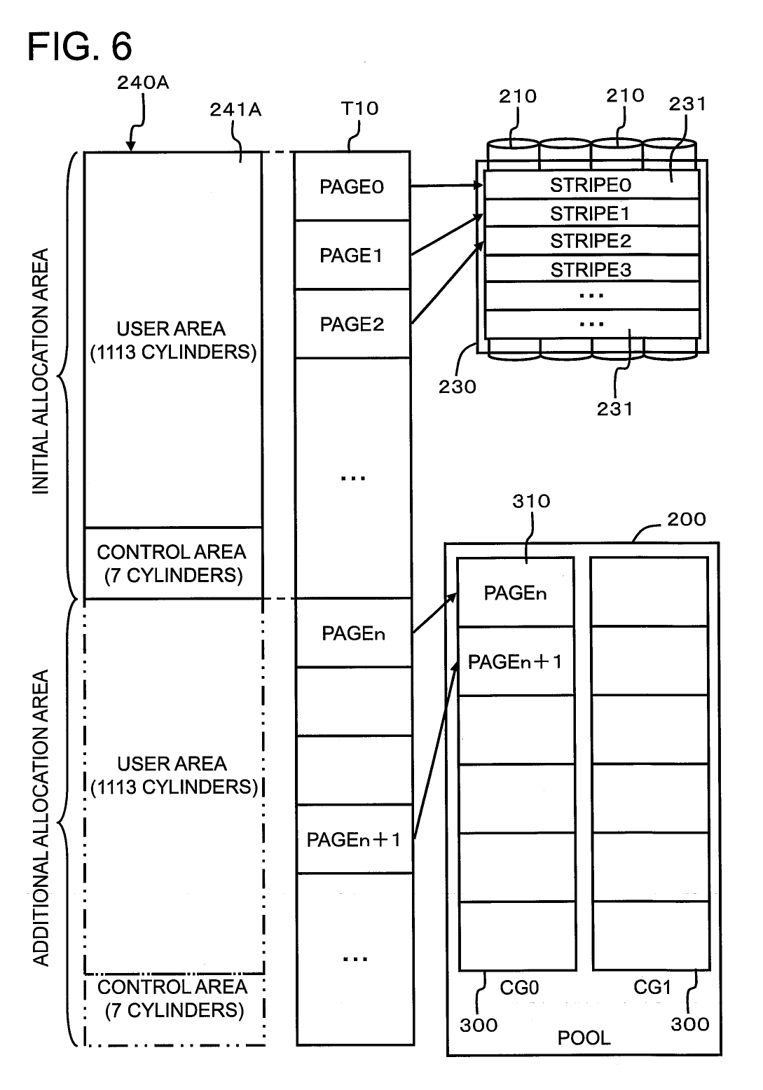

FIG. 6 shows how the virtual logical volume 240 is created by including a stripe 231 of the logical volume 230 and a page 310 from inside the pool 200. In the example of FIG. 6, the initial allocation area 240A is configured from the actual logical volume 230. That is, the virtual logical volume 240, which comprises only the initial allocation area 240A, does not exist virtually, but rather is substantially the same as an ordinary logical volume.

A page 310 inside the pool 200 is allocated to the additional allocation area 240B. More specifically, a page 310 inside the cylinder group 300, which has been selected as the additional allocation area 240B, is allocated to the additional allocation area 240B in accordance with a write request.

The upper half of the mapping management information T10 (from page number 0 until just before page number n) manages the corresponding relationship between the unit areas (page areas) that configure the initial allocation area 240A and the stripes 231 of the actual logical volume 230.

The lower half of the mapping management information T10 (page number n and beyond) manages the corresponding relationship between the unit areas configuring the additional allocation area 240B and the pages 310 inside the pool 200.

As shown in FIG. 6, the virtual logical volume 240 may also be integrally configured from an ordinary logical volume 230 and a plurality of pages 310 from inside the pool 200. In this case as well, management can be performed using the same configuration mapping management information T10.

FIG. 7 shows the relationship of the user area 241 and the control area 242 to the page 310, the cylinder 320, and the track 330. As mentioned hereinabove, the virtual logical volume 240 (=user area 241+control area 242) is configured from one cylinder group 300.

The cylinder group 300 comprises an integral number of (for example 25) pages 310. The cylinder group 300, for example, comprises 1120 cylinders 320. Each cylinder 320 comprises 15 tracks 330.

In this example, the track size is 58 kB. The cylinder group 300 comprises 16800 (=1120×15) tracks 330. Meanwhile, in this example, the page size is 38 MB. 38 MB is equivalent to 38976 kB. Therefore, one page is configured from 672 tracks 330 (38976/58=672). Since one cylinder group 300 is configured from 16800 tracks 330, the size of this one cylinder group 300 is equivalent to 25 pages (16800/672=25).

The virtual logical volume 240 can be expanded like this by treating the cylinder group 300, which is 25 pages in size, as a unit. Therefore, it is possible to prevent a plurality of different real storage areas from being associated with page information of a page 310 adjacent to another cylinder group 300 from among the page information configured from the mapping management information T10.

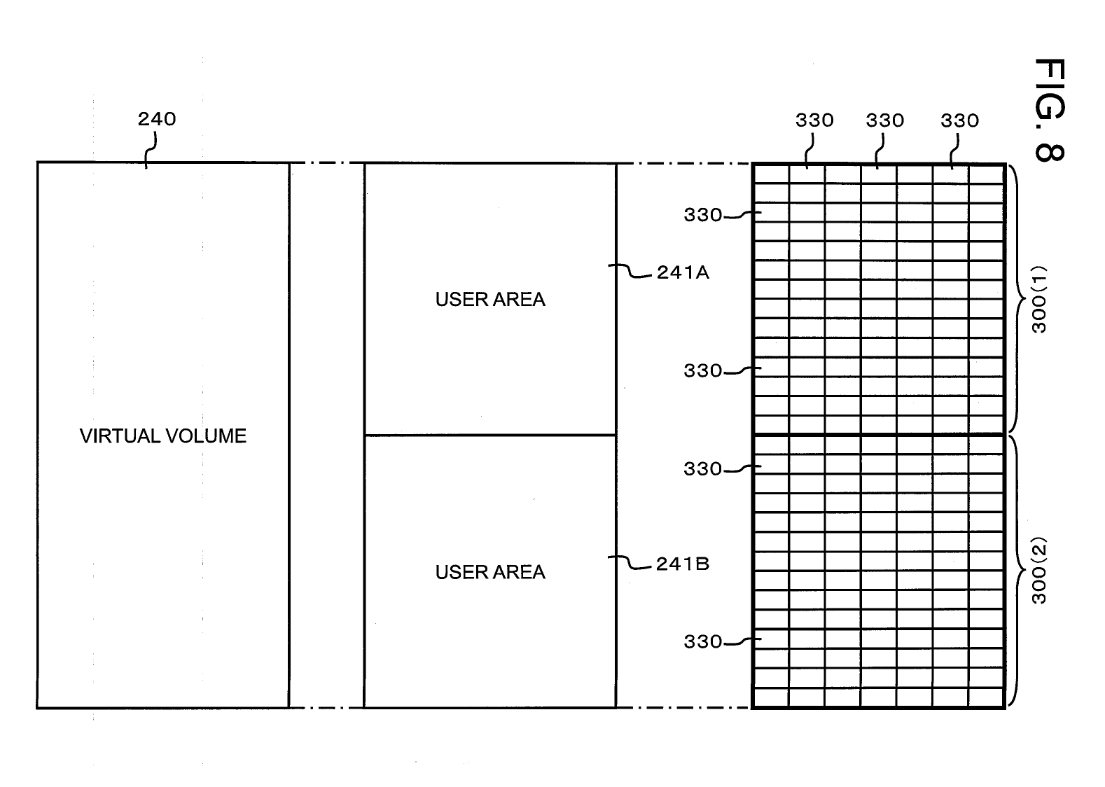

FIG. 8 shows the virtual logical volume 240 as seen from the host 20. Even when the virtual logical volume 240 is configured from a plurality of cylinder groups 300 (1) and 300 (2), the host 20 recognizes it as a single virtual logical volume 240.

In addition, only the contiguous areas of the user area 241A and the user area 241B can be seen from the host 20; the control areas 242A and 242B shown in FIG. 5 are not visible.

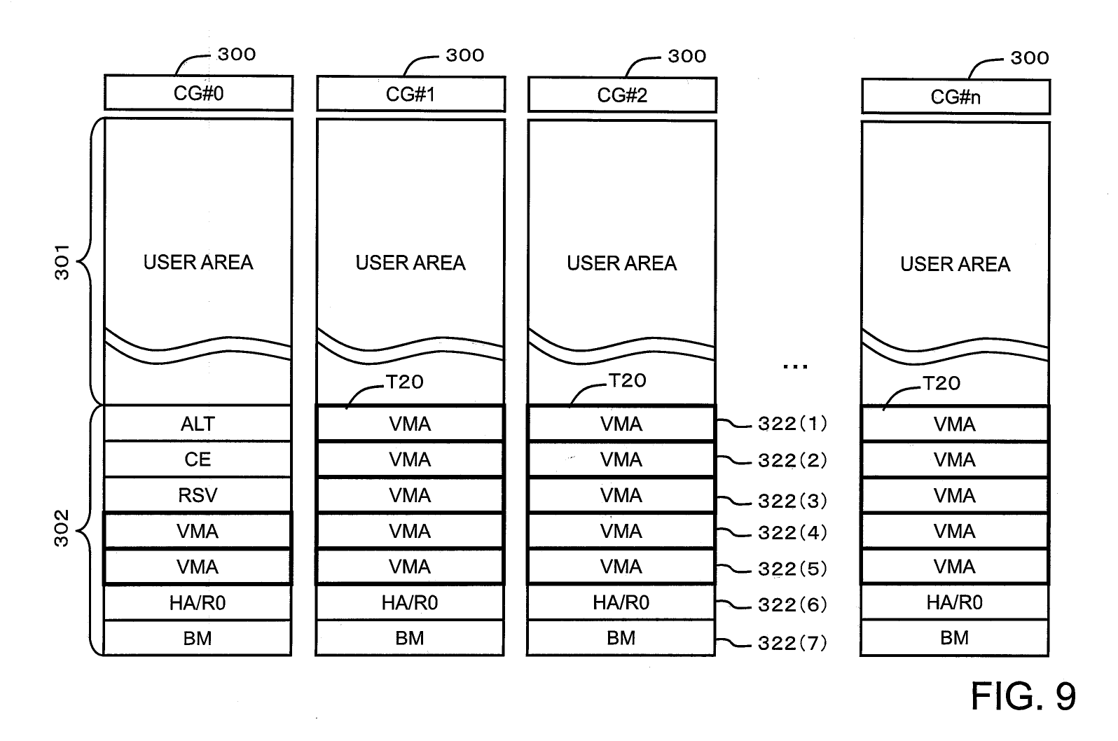

FIG. 9 shows the configuration of the cylinder group 300. As described hereinabove, the cylinder group 300 is the basic unit for expanding the volume size of the virtual logical volume 240. The real storage area of the cylinder group 300 can be divided into a user area 301 and a control area 302. The user area 301 is the real storage area allocated to the user area 241 of the virtual logical volume 240. The control area 302 is the real storage area allocated to the control area 242 of the virtual logical volume 240.

The control area 302, as described hereinabove, is the size of seven cylinders. The information stored in the control area 302 of the first cylinder group 300 (CG#0) will differ from that in the subsequent cylinder groups 300 (CG#1 through CG#n).

The control area 302 of the first cylinder group 300 (CG#0) comprises ALT information (the first cylinder storage area), CE information (the second cylinder storage area), RSV information (the third cylinder storage area), VMA (the fourth and fifth cylinder storage areas), HA/R0 (the sixth cylinder storage area), and BM information (the seventh cylinder storage area). The cylinder storage area is a storage area the size of a single cylinder. VMA is the abbreviation for Virtual Management Area.

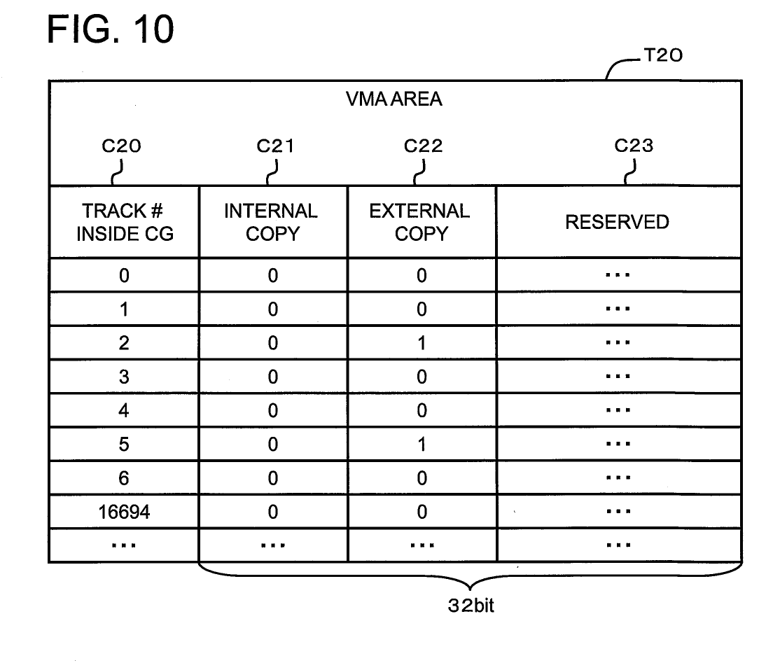

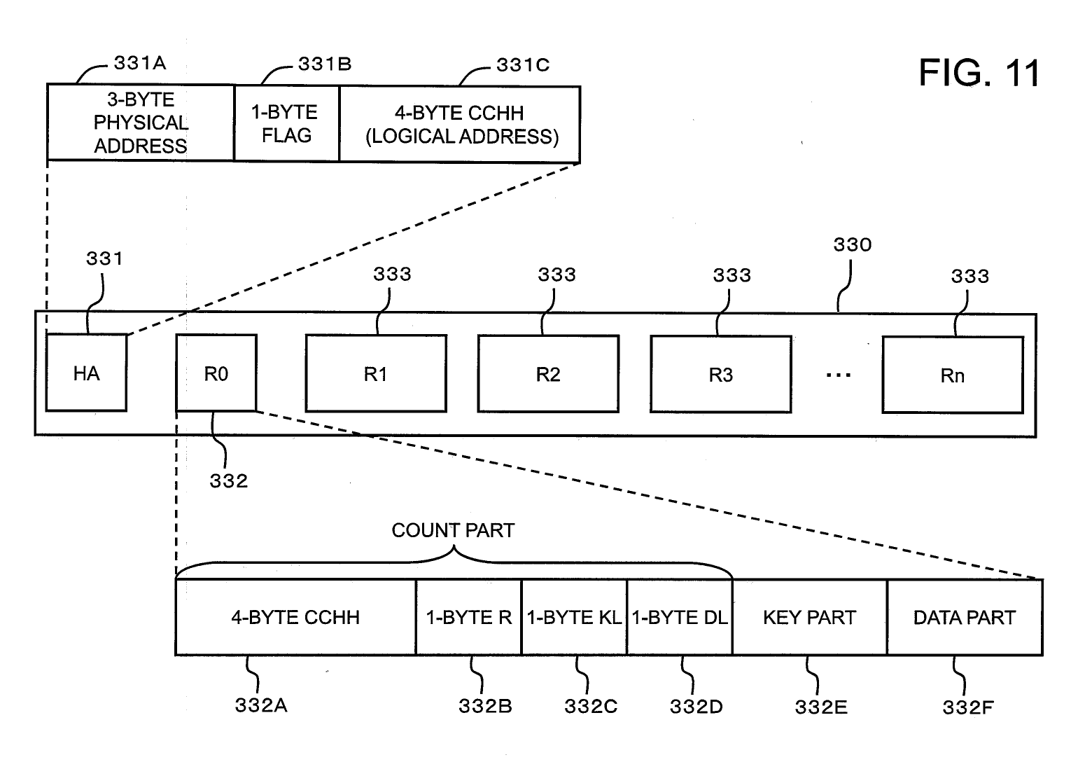

VMA as the “copy management information” will be explained using FIG. 10. The HA/R0 configuration will be explained using FIG. 11. Explanations of the other information, such as ALT and CE, will be omitted since they are not related to the characteristic features of the present invention.

In the second and subsequent cylinder groups 300 (CG#1 through CG#n), the first cylinder storage area 322 (1) through the fifth cylinder storage area 322 (5) may be used as VMA areas. The sixth cylinder storage area 322 (6) and the seventh cylinder storage area 322 (7) store the HA/R0 and so forth the same as the control area 302 of the first cylinder group 300 (CG#0).

The control areas 302 of the second and subsequent cylinder groups 300 (CG#1 through CG#n) are configured such that it is possible to respectively store the VMA in five cylinder storage areas 322. In a case where only the difference of either a remote copy (external copy) or an internal copy is managed, there is no need for five cylinder areas. In this example, enough areas are secured for storing control information so that a function other than that for managing a difference copy may be added. In a case where it is not necessary to consider the expansion of functions in the future, fewer VMA areas may be secured in the control area 302.

FIG. 10 shows an example of the configuration of the VMA area T20. In this example, either VMA or VMA area will be used. The VMA area T20, for example, is associated with a flag C21 denoting an internal copy, a flag C22 denoting an external copy, and a reserved bit group C23 for each track number C20 inside the cylinder group.

The total size of the C21, C22, and C23, for example, is set at 32 bits, that is, 4 bytes. This is broken down into one bit for the internal copy flag C21, one bit for the external copy flag C22, and 30 bits for the reserved bit group C23.

A case where an internal copy is performed with respect to the virtual logical volume 240 will be explained. When a track 330 inside a page 310, which has been allocated to the virtual logical volume 240, is updated by the host 20, 1 is set in the internal copy flag C21 inside the VMA area T20 corresponding to this updated track.

A case where an external copy is performed in the virtual logical volume 240 will be explained. When a track 330 inside a page 310, which has been allocated to the virtual logical volume 240, is updated by the host 20, 1 is set in the external copy flag C22 inside the VMA area T20 corresponding to this updated track.

When difference data is transferred to the copy-destination volume from the virtual logical volume 240, which is the copy-source volume, and the storage contents of the copy-source volume and the copy-destination volume are made identical, either the internal copy flag C21 or the external copy flag C22 is reset.

Either one of the internal copy flag C21 or the external copy flag C22 may be exclusively set, and the two may be set together. For example, there is a case where data is copied from the virtual logical volume 240, which is the copy-source volume, to two copy-destination volumes.

In this case, it is supposed that the one copy-destination volume is managed by the storage control apparatus 10 (1), and that the other copy-destination volume is managed by the storage control apparatus 10 (2). An internal copy is carried out between the virtual logical volume 240 and the one copy-destination volume. An external copy is carried out between the virtual logical volume 240 and the other copy-destination volume. Therefore, in a case where both an internal copy and an external copy are carried out with respect to the virtual logical volume 240, both the internal copy flag C21 and the external copy flag C22 are used.

In addition, a case in which a plurality of either internal copies or external copies are performed is also possible. In this case, the reserved bit group C23 may be reduced slightly, and the copy flags C21 and C22 may be increased.

The number C20 for identifying the tracks 330 inside the cylinder group 300 is shown in the drawing to expedite the explanation. Actually, there is no need to store the track number in the VMA area T20.

It is sufficient to arrange the internal copy flag C21, the external copy flag C22, and the reserved bit group C23 in the order of the respective tracks 330 configuring the user area 301. This is because arranging the information C21, C22 and C23 in order makes it possible to easily identify the location of the control information C21, C22, C23 corresponding to a prescribed track inside the user area 301.

A method for identifying the control information C21, C22, C23 will be explained. First, a method for identifying a track to be accessed by the host 20 will be explained.

In this example, a value denoting the number of contiguous tracks from the first track of the virtual logical volume 240 will be called the absolute track number (this may be abbreviated as ATN). A number, which excludes the tracks configuring the control area and shows the number of contiguous tracks of the respective user areas will be called the internal track number (this may be abbreviated as ITN). The internal track number is information for identifying a track that will be recognized by the host 20.

This will be explained by giving a specific example. It is supposed that the access destination of the host 20 is “cylinder number 1114, track number 5”. One cylinder is configured from 15 tracks. Therefore, the absolute track number is determined by using Equation 1 below.

Absolute track number=1114×15+5=16715 (Equation 1)

As described hereinabove, the host 20 only sees the user area; the control area is not recognized by the host 20. In a case where two cylinder groups CG0 and CG1 have been allocated to the virtual logical volume 240, as explained using FIG. 8, the user areas inside the respective cylinder groups are seen as one contiguous area by the host 20.

Therefore, host access to the “cylinder number 1114, track number 5” does not denote the control area inside the first cylinder group, but rather points to the user area of the next cylinder group.

Accordingly, the absolute track number 16715 obtained via Equation 1 is divided by 16695 (=1113×15), which is the total number of tracks of the user area. In accordance with this, it is possible to find the internal track. In a case where 16715 is divided by 16695, the quotient becomes the number of the cylinder group that comprises the track that the host is attempting to access, and the remainder is the track number inside the access-destination cylinder group. In the above example, since the quotient is 1 and the remainder is 20, the 20^{th} track from the start of the cylinder group CG1 is the access-destination track of the host 20. That is, the internal track number may be calculated using Equation 2 below.

Internal track number=(1120×CG#)+(ATN mod 16695) (Equation 2)

In the above example, (1120×1)+(the remainder obtained by dividing 16715 by 16695 (20))=1140 is the internal track number.

Next, a method for calculating the storage location of the control information in the above example will be explained. The number of the first track of the control area for storing the control information corresponding to the host access-destination track may be found by using the following Equation 3.

Track number=1113×(CG#+1)+(7×CG#)×15 (Equation 3)

The “1113×(CG#+1)” denotes the number of tracks of the user area. In the above example, since the number of the access-targeted cylinder group (the cylinder group comprising the control information) is 1, 1113× (1+1)=2226.

The “(7×CG#)×15” denotes the number of tracks of the control area included in the cylinder group previous to the access-targeted cylinder group. In the above example, the target cylinder group is CG1, and therefore (7×1)×15=105.

Therefore, the absolute track number of the control area for storing the control information corresponding to the host access-destination track becomes 1113× (1+1)+(7×1)×15=2331. The control area corresponding to the track to be updated by the host 20 can be easily calculated from the host access-destination address.

One page is configured from 672 tracks here. Therefore, a value obtained by dividing the absolute track number determined by Equation 1 by 672 and rounding off after the decimal point is the number of the page for which this value was allocated to the control area. In a case where the page number corresponding to the control area is identifiable, it is possible to quickly find where in the mapping management information T10 the control information is being managed.

Even in a case where a plurality of cylinder groups 300 are associated with the virtual logical volume 240, it is possible to easily find the access-destination track of the host 20 and the location of the control information corresponding to this track using the above calculation method.

FIG. 11 shows details of the HA/R0 in FIG. 9. The track 330 comprises, in order from the start thereof, a HA 331, a R0_332, and a plurality of user records 333.

The HA 331 comprises a physical address 331A, a flag 331B, and a CCHH 331C. The physical address 331A is 3 bytes, the flag 331B is 1 byte, and the CCHH 331C is 4 bytes. Therefore, the HA 331 is 8 bytes. The CCHH 331C denotes a logical address. CC is a logical cylinder address. HH is a logical head address. User data is written into the user record 333.

The R0_332 comprises a CCHH 332A, a logical record number 332B, a key length 332C, a data length 332D, a KEY part 332E, and a DATA part 332F. The CCHH 332A is a 4-byte logical address.

The logical record number 332B, the key length 332C and the data length 332D are each one byte. The KEY part 332E and the DATA part 332F are not being used. The eight bytes from the CCHH 332A up to the data length 332D configure the COUNT part.

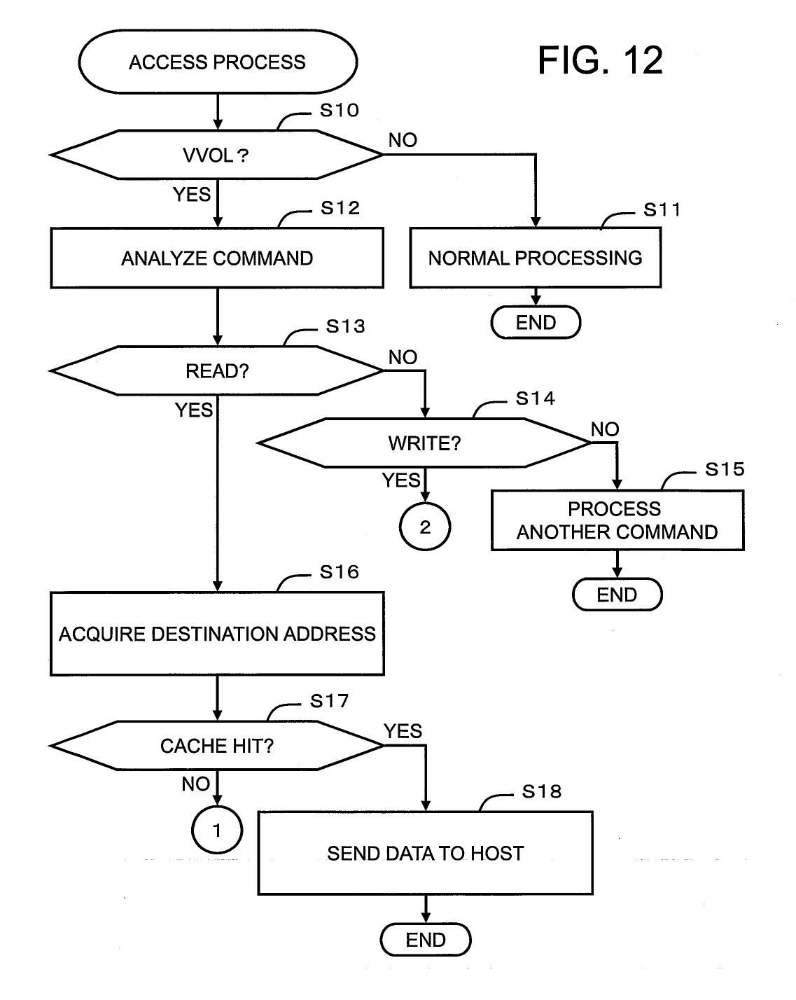

The access process will be explained by referring to FIGS. 12 through 14. The following processes are executed by the controller 100. Therefore, the controller is the subject.

An access request from the host 20 is received by the first communication interface circuit 110. The controller determines whether or not the access target of the host 20 is the virtual logical volume (VVOL) (S10).

In a case where the host 20 access target is the ordinary logical volume 230 (S10: NO), ordinary processing is performed (S11). The controller executes any of an ordinary read process, write process, or other command process.

In a case where the host 20 access target is the virtual logical volume 240 (S10: YES), the controller analyzes the access request command (S12). The controller determines whether or not the access request is a read request (S13).

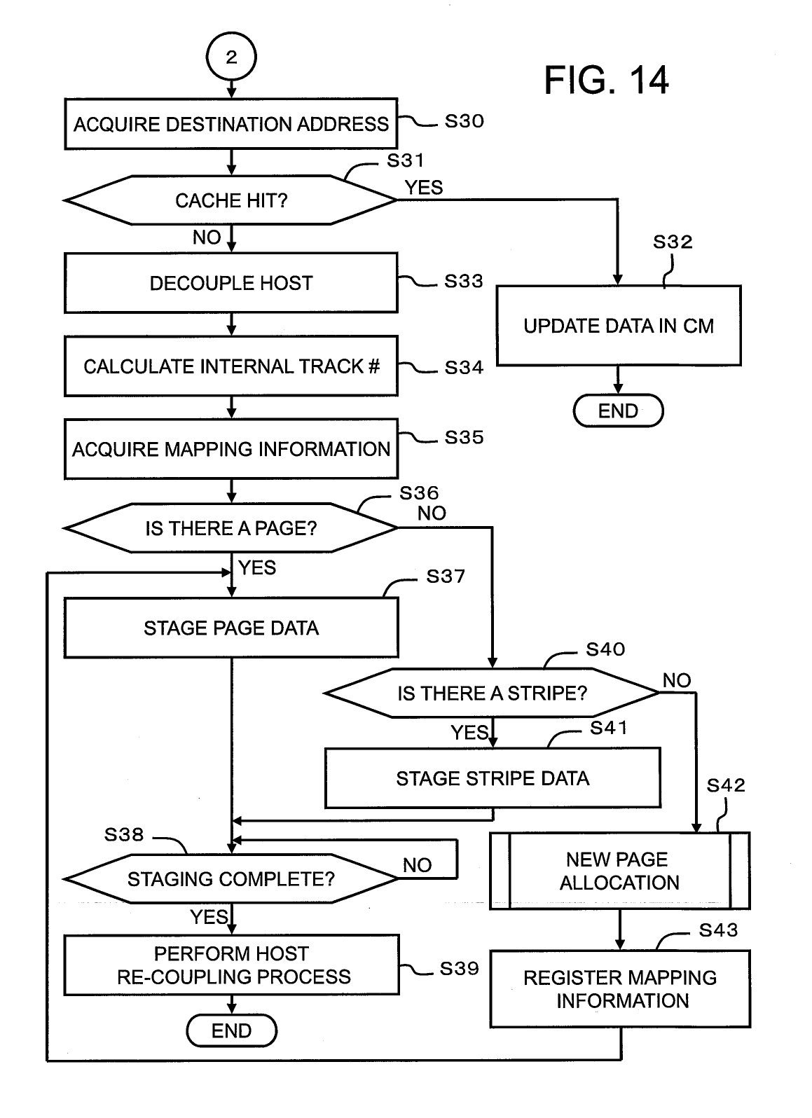

In a case where the access request is not a read request (S13: NO), the controller determines whether or not the access request is a write request (S14). In a case where the access request is a write request (S14: YES), the controller executes the write processing shown in FIG. 14. The write process will be explained hereinbelow.

In a case where the access request is not a write request (S14: NO), the controller performs another command process (S15). Another command, for example, may include a variety of query commands, such as a volume size query. The controller implements processing in accordance with the other command, and returns the result to the host 20 (S15).

In a case where the access request issued by the host 20 is a read request (S13: YES), the controller acquires the host access-destination address (the CCHH included in the command) (S16).

The controller determines whether or not the data identified by the access-destination address is stored in the cache memory 130 (S17). In a case where the data requested by the host 20 is stored in the cache memory 130 (S17: YES), the controller reads this data from the cache memory 130 and sends this data to the host 20 (S18).

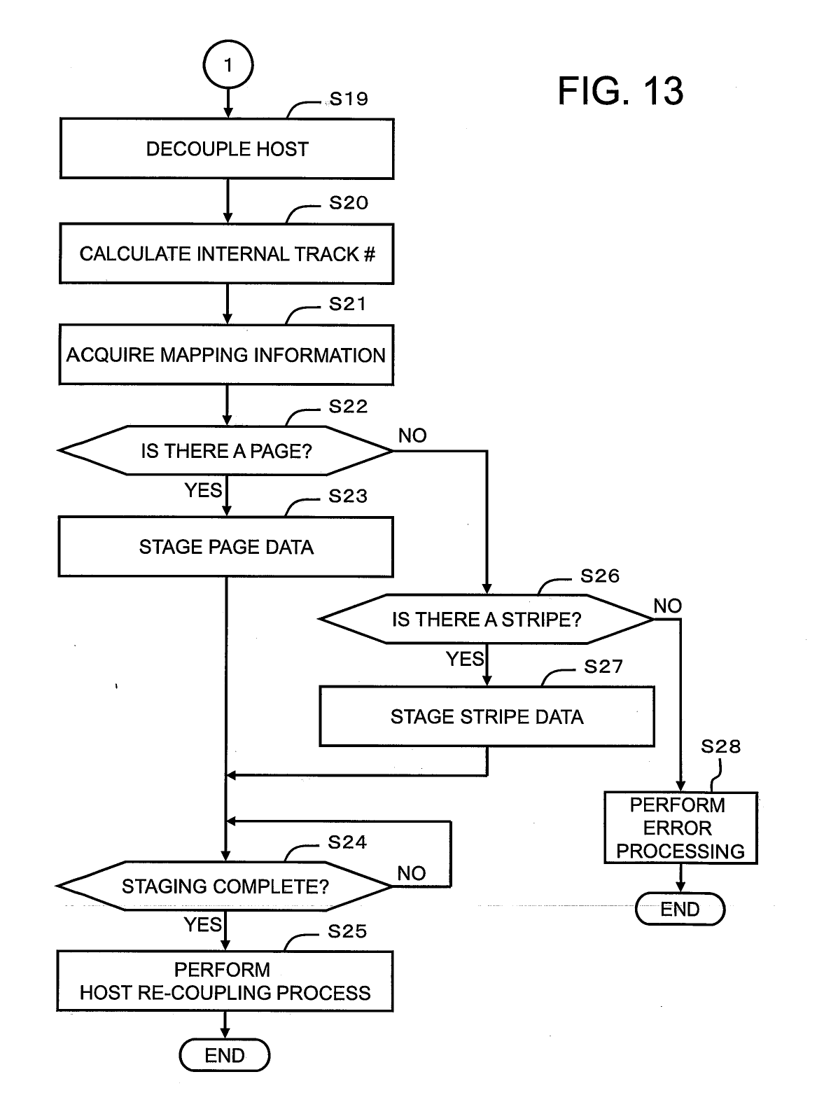

In a case where the data requested by the host 20 is not stored in the cache memory 130 (S17: NO), processing returns to that shown in FIG. 13, the controller decouples from the host 20 (S19), and the controller calculates the internal track number of the track where the data requested by the host 20 is stored (S20).

The controller acquires information from the mapping management information T10 based on the track number (S21). The controller determines whether or not there exists a page 310 that corresponds to the requested data (S22).

In a case where a page 310 within the address space of the virtual logical volume 240 has been allocated to the access destination of the host 20 (S22: YES), the controller stages the data of this page (S23). Staging signifies transferring the data to the cache memory 130.

When staging is complete (S24: YES), the controller executes processing for coupling to the host 20 once again (S25). After recoupling, the read request is issued from the host 20 once again. The read-targeted data has been stored in the cache memory 130 in accordance with S23 and S24. Therefore, the controller sends the data stored in the cache memory 130 to the host 20 (S18), and ends this processing.

In a case were a page 310 has not been allocated to the read-targeted data (S22: NO), the controller determines whether or not a stripe 231 has been allocated (S26). That is, the controller determines whether or not a stripe 231 within the address space of the virtual logical volume 240 has been allocated to the access destination of the host 20. In a case where a stripe 231 has been allocated (S26: YES), the controller stages the data in this stripe (S27).

Next, as mentioned above, when the controller confirms the transfers of the data from the stripe to the cache memory 130 (S24: YES), the controller recouples to the host 20 (S25). The controller sends the data inside the cache memory 130 to the host 20 in accordance with the new read request from the host 20 (S18).

In a case where the read-targeted data is not associated with either a page or a stripe (S26: NO), the controller performs error processing (S28). In the error processing, for example, the controller notifies the host 20 to the effect that read-requested data does not exist. Under normal circumstances, the host 20, subsequent to writing data to the virtual logical volume 240, reads back this data. Therefore, the likelihood of the error processing of S28 being carried out is low.

FIG. 14 shows a write process. The controller acquires the access-destination address of the host 20 (S30). The controller determines whether or not the update-targeted data is stored in the cache memory 130 (S31). In a case where the update-targeted data is stored in the cache memory 130 (S31: YES), the controller updates the data stored in the cache memory 130 in accordance with the request of the host 20 (S32). Furthermore, the data that has been updated in the cache memory 130 is written at the appropriate time to the logical volume, which provides either a page or a stripe.

In a case where the update-targeted data is not stored in the cache memory 130 (S31: NO), the controller temporarily terminates the coupling with the host 20 (S33). The controller calculates the internal track number of the update-targeted data on the basis of the CCHH (S34), and acquires information from the mapping management information T10 (S35).

The controller, based on the information acquired from the mapping management information T10, determines whether or not the update-targeted data is stored in a page 310 (S36). In a case where the update-targeted data is stored in a page 310 (S36: YES), the controller stages the data in this page (S37).

When staging is complete (S38: YES), the controller recouples to the host 20 (S39). The host 20 reissues the write request. The data, which the host 20 wishes to update, has been stored in the cache memory 130 in accordance with S37 and S38. Therefore, the controller updates the data in the cache memory 130 (S32), and ends this processing.

In a case where it has been determined that the update-targeted data is not stored in a page 310 (S36: NO), the controller determines whether or not the update-targeted data is stored in a stripe 231 (S40).

In a case where the update-targeted data is stored in a stripe (S40: YES), the controller stages the data in this stripe (S41). Next, the same as mentioned above, after the staging is complete (S38: YES), the controller recouples with the host 20 (S39). The controller, based on a reissued write request, updates the data that has been stored in the cache memory 130 (S32), and ends this processing.

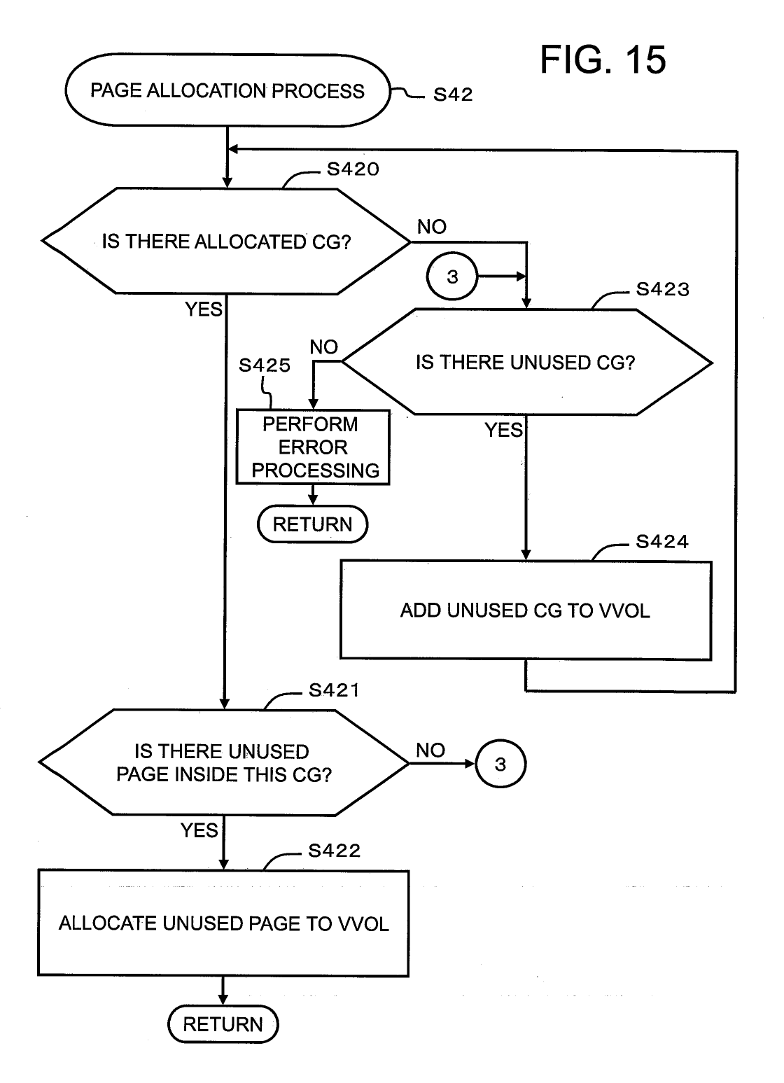

In a case where the update-targeted data has not been allocated to either a page or a stripe (S40: NO), there is a new data write. Accordingly, the controller allocates a page for storing the new data to a prescribed location of the virtual logical volume 240 (S42). The prescribed location is a page-sized area comprising the write-destination address. The process for allocating a new page will be explained using FIG. 15. The controller, after allocating a new page to the virtual logical volume 240, registers the management information in the mapping management information T10 (S43). That is, the controller associates the information denoting the actual location of the page with the virtual logical volume address to which this page has been allocated, and records this association in the mapping management information T10.

Thereafter, the controller moves to S37 and stages the data of the newly allocated page (S37).

FIG. 15 shows the details of the page allocation process of S42 in FIG. 14. The controller determines whether or not there is a cylinder group 300 that has been allocated to the virtual logical volume 240 (S420).

In a case where an allocated cylinder group 300 exists (S420: YES), the controller determines whether or not there is an unallocated page 310 inside this cylinder group 300 (S421). In a case where an unallocated page (an unused page) exists inside the allocated cylinder group 300 (S421: YES), the controller allocates this unused page to the virtual logical volume (S422).

In a case where either a cylinder group 300 has not been allocated to the virtual logical volume 240 (S420: NO), or there are no unused pages inside the allocated cylinder group 300 (S421: NO), the controller determines whether or not there is an unused cylinder group 300 inside the pool 200 (S423).

In a case where an unused cylinder group 300 exists (S423: YES), the controller adds this unused cylinder group 300 to the virtual logical volume 240 anew (S424). That is, the size of the virtual logical volume 240 is automatically expanded.

However, a configuration in which the size of the virtual logical volume 240 can be expanded in cylinder group units only in accordance with a user operation may also be used. In this case, the configuration may be such that S423 and S424 are omitted, and error processing (S425) is performed when a determination of NO is made in S420.

In a case where an unused cylinder group 300 does not exist (S423: NO), the controller performs error processing (S425). In this error processing, for example, the controller notifies the host 20 to the effect that there is no free space in the volume size, and the write data is unable to be written.

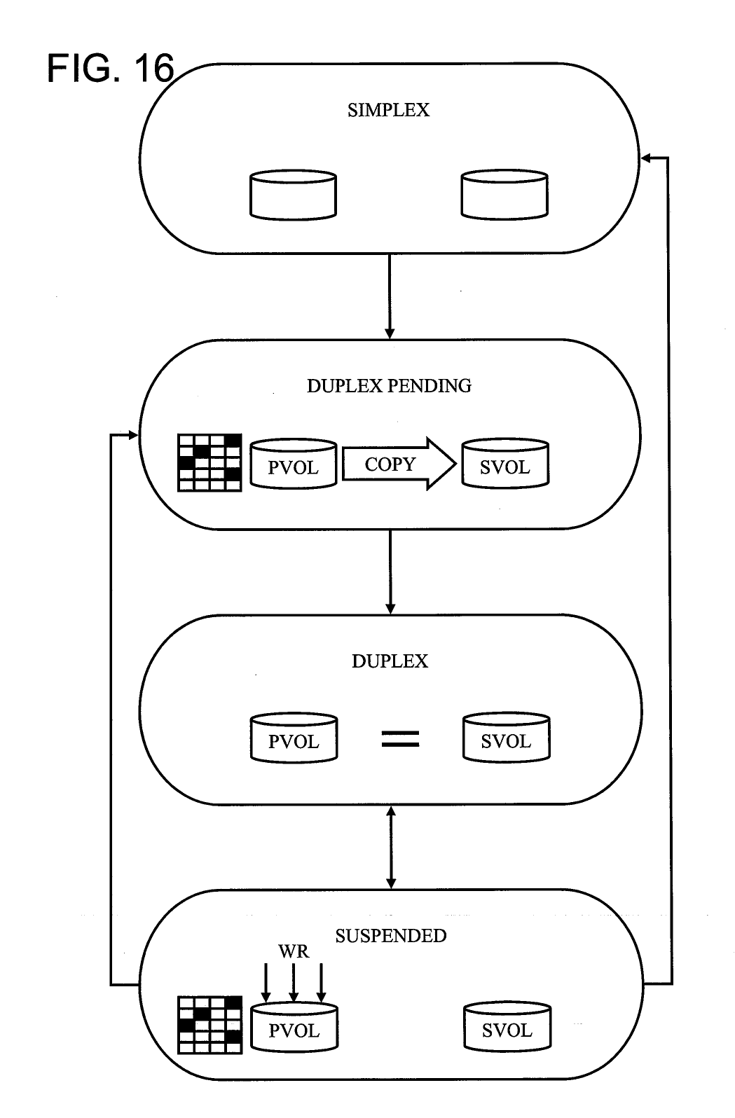

FIG. 16 shows the status transitions of a copy. A copy is broadly divided into an internal copy and an external copy. The internal copy is a process for replicating the logical volume inside the same storage control apparatus 10. The external copy is a process for replicating the logical volume between different storage control apparatuses 10 (1) and 10 (2). The external copy is all called a remote copy.

“SIMPLEX” in FIG. 16 denotes a state in which a copy-pair is not created. “DUPLEX PENDING” denotes a state in which data is being copied from the primary volume (the copy-source volume) to the secondary volume (the copy-destination volume). “DUPLEX” denotes a state in which the data stored in the primary volume and the data stored in the secondary volume are identical. “SUSPENDED” denotes a state in which the replication statuses of the primary volume and the secondary volume are temporarily suspended.

A case in which the host 20 has updated the data inside the primary volume in the SUSPENDED state will be considered. In this case, it becomes impossible to synchronize the storage contents of the primary volume and the secondary volume unless information as to what data has been updated at what address has been stored.

Copy management information (copy management information that serves as control information) for managing the difference between the primary volume storage content and the secondary volume storage content must be stored somewhere. Accordingly, in this example, the copy management information is stored inside a cylinder group that is to be allocated to the virtual logical volume 240. That is, in this example, the copy management information is stored in the logical volume, which is the basis of the virtual logical volume.

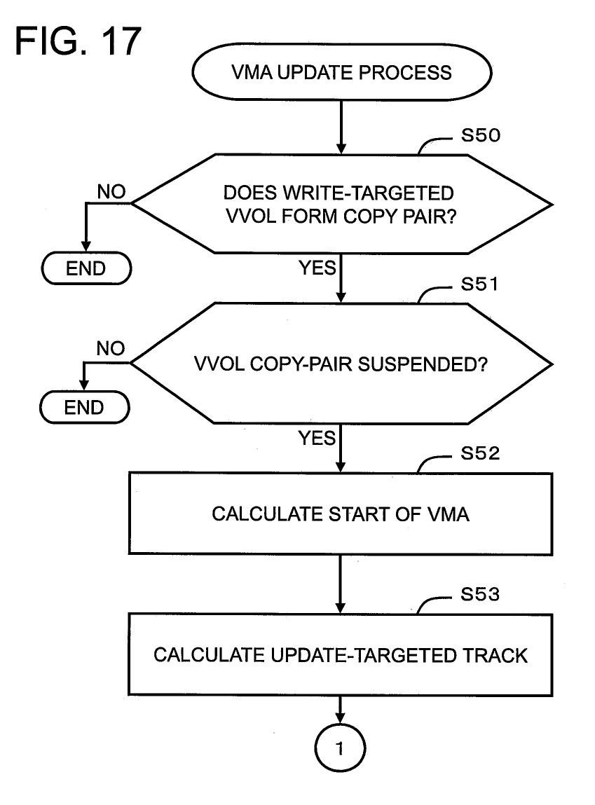

FIG. 17 shows a process for updating the copy management information (VMA). The controller determines whether or not the virtual logical volume 240 that is the write target of the host 20 forms a copy-pair (S50).

In the case of a virtual logical volume 240 that has not been set as a copy-pair (S50: NO), the controller ends this processing since there is no need to update the copy management information (VMA).

In a case where a virtual logical volume 240, which is set as a copy-pair, is the write-target of the host 20 (S50: YES), the controller determines whether or not this virtual logical volume 240 is in the SUSPENDED state (S51). In a case where this virtual logical volume 240 is not in the SUSPENDED state (S51: NO), the controller ends this processing since there is no need to manage a difference.

In a case where this virtual logical volume 240 is in the SUSPENDED state (S51: YES), the controller, as described hereinabove, calculates the start of the VMA (the start of the control area) based on the write-destination address of the host 20 (S52). The controller calculates the number of the track to be updated from among the tracks included in this VMA (S53).

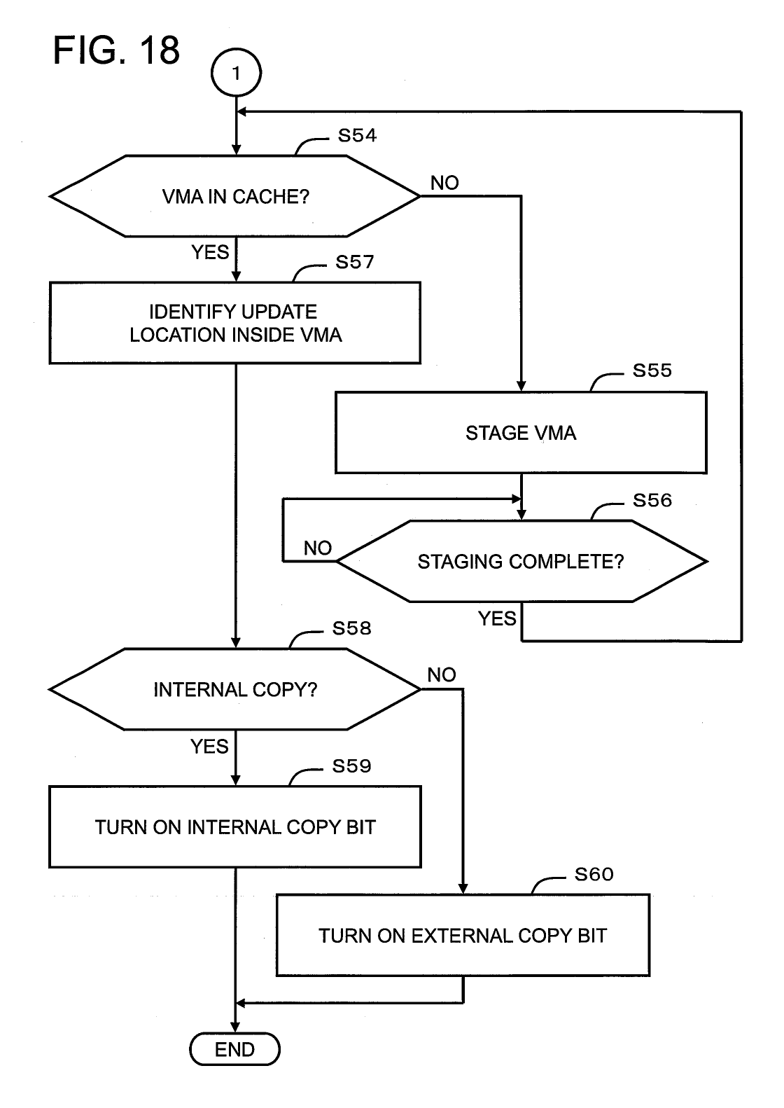

Move to FIG. 18. The controller determines whether or not the VMA data to be updated is stored in the cache memory 130 (S54).

In a case where the VMA data to be updated is not stored in the cache memory 130 (S54: NO), the controller stages the VMA that is stored in the logical volume (55). When staging is complete (D56: YES), processing returns to S54. This time, the determination made in S54 is YES.

In a case where the update-target VMA is stored in the cache memory 130 (S54: YES), the controller identifies the location to be updated within this VMA (S55). In addition, the controller determines whether or not the copy-pair formed with respect to the virtual logical volume 240 is an internal copy (S58).

In the case of an internal copy (S58: YES), the controller sets 1 in the internal copy flag C21 corresponding to the update-targeted track (S59). In a case where the copy-pair is not an internal copy (S58: NO), the controller sets 1 in the external copy flag C22 corresponding to the update-targeted track (S60).

According to the above-described processing, when the data in the virtual logical volume 240, which is the copy-source volume (primary volume), is to be updated by the host 20, a copy flag corresponding to this updated track is set in the VMA area T20. Therefore, it is possible to manage a difference in the copy-pair.

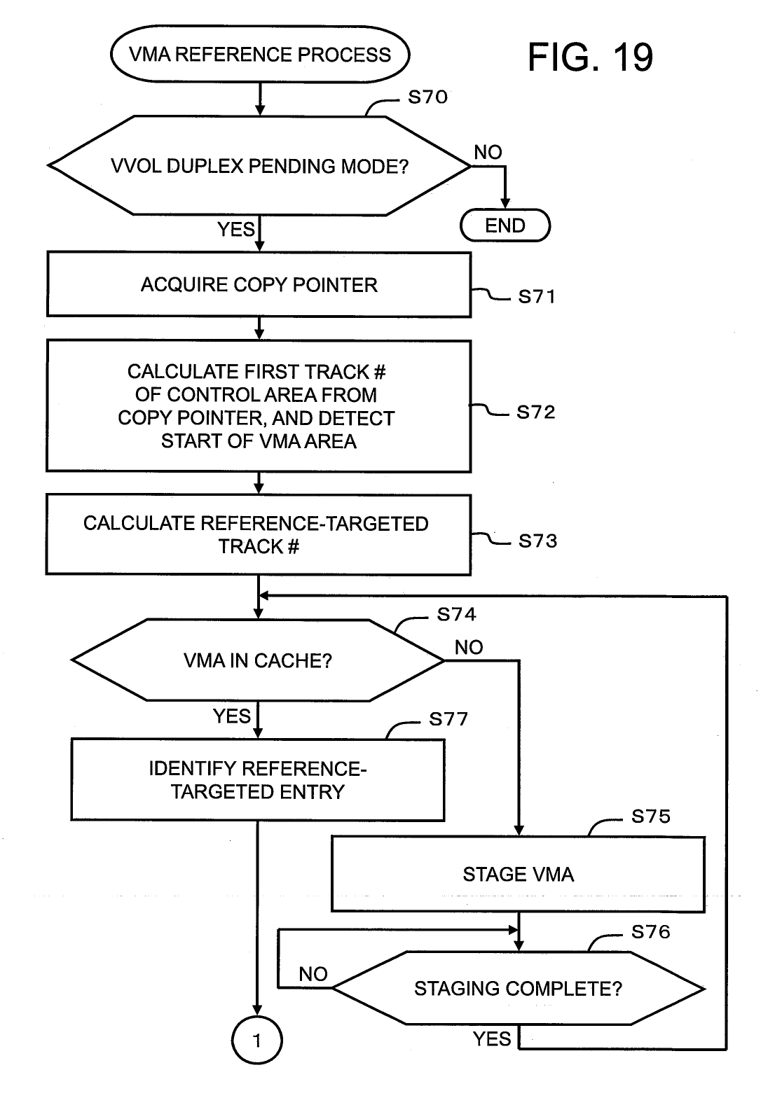

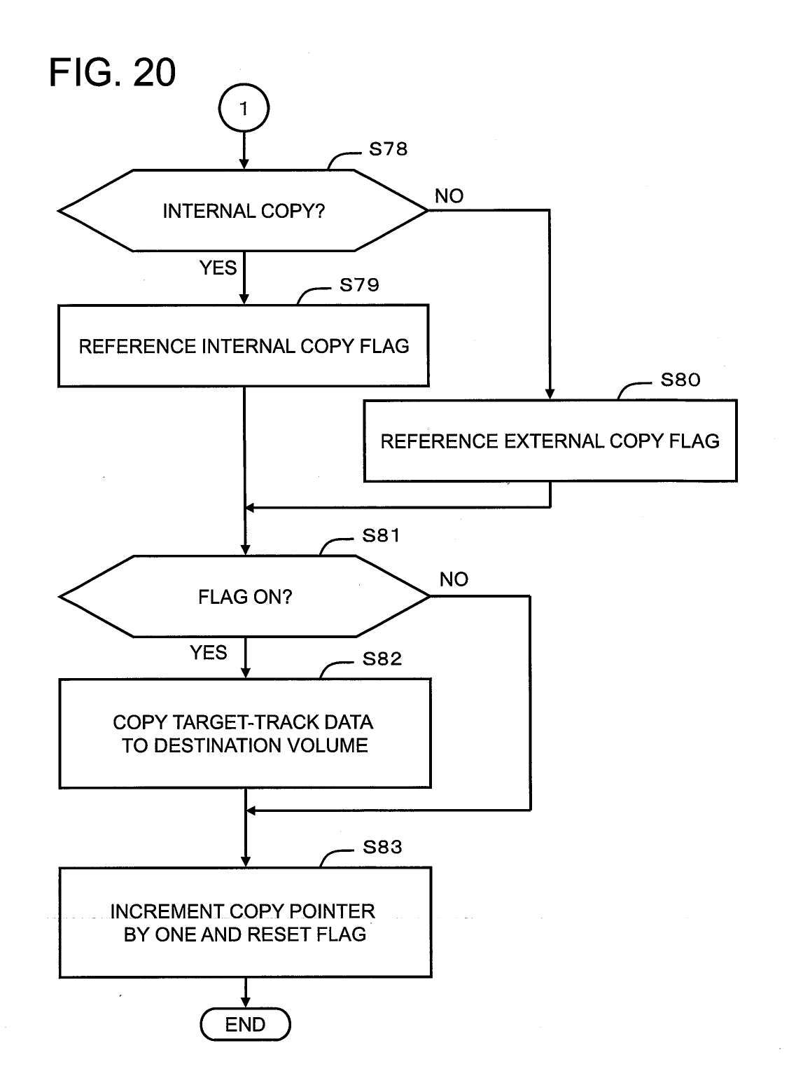

FIGS. 19 and 20 show a process for referencing the VMA. This process is executed when transferring difference data from the virtual logical volume 240 to the copy-destination volume to resynchronize the copy-destination volume with the virtual logical volume 240.

The controller determines whether or not the virtual logical volume 240 is in the DUPLEX PENDING state (S70). In a case where the virtual logical volume 240 is in the DUPLEX PENDING state (S70: YES), the controller acquires a copy pointer for managing the progress of the difference copy (S71).

The controller calculates the cylinder group number on the basis of the value of the copy pointer, also calculates the number of the first track of the control area of this cylinder group, and, in addition, calculates the start of the VMA inside the control area (S72).

The controller calculates the reference-targeted track number (S73). The controller determines whether or not the VMA is stored in the cache memory 130 (S74). In a case where the VMA is not stored in the cache memory 130 (S74: NO), the controller stages the VMA from the page 310 where the VMA is stored (S75). When staging is complete (S76: YES), the controller returns to S74 and determines whether or not there is a cache hit. This time the determination is that there is a cache hit (S74: YES).

In a case where the VMA is stored in the cache memory 130 (S74: YES), the controller identifies the entry to be referenced in the VMA (S77). Move to FIG. 20. The controller determines whether or not an internal copy has been set with respect to the virtual logical volume 240 (S78).

In a case where an internal copy has been set with respect to the virtual logical volume 240 (S78: YES), the controller references the value of the internal copy flag C21 (S79). In a case where an internal copy has not been set with respect to the virtual logical volume (S78: NO), the controller references the value of the external copy flag C22 (S80).

The controller determines whether or not an internal copy flag C21 or an external copy flag C22 has been set (S81). In a case where a copy flag has been set (S81: YES), the controller copies the data of the track where a difference has occurred by transferring this data to the copy-destination volume (S82). The controller increments the value of the copy pointer by one (S83).

In a case where a copy flag has not been set (S81: NO), the controller skips S82 and proceeds to S83.

Since configuring this example like this makes it possible to expand the size of the virtual logical volume in units of a cylinder group 300, which is 25 pages in size, there is no way that respectively different pages are intermixed and allocated to a certain page area of the virtual logical volume 240, or that a page and a stripe are intermixed and allocated to a certain page area of the virtual logical volume 240.

In this example, a control area is disposed inside the cylinder group, which is the expansion unit of the virtual logical volume 240, and copy management information (VMA) is stored in the control area. Therefore, the expansion of the size of the virtual logical volume 240 can be dealt with easily. In addition, this example makes it possible to prevent the generation of an idle area more than in a case where the size of the copy management information is created to coincide with the maximum size to which the virtual logical volume is capable of being expanded.

In this example, a control area is provided for each fixed-size cylinder group, and control information is stored in this control area. Therefore, it is possible to calculate the location of control information corresponding to a track inside the user area using a relatively simple computational expression.

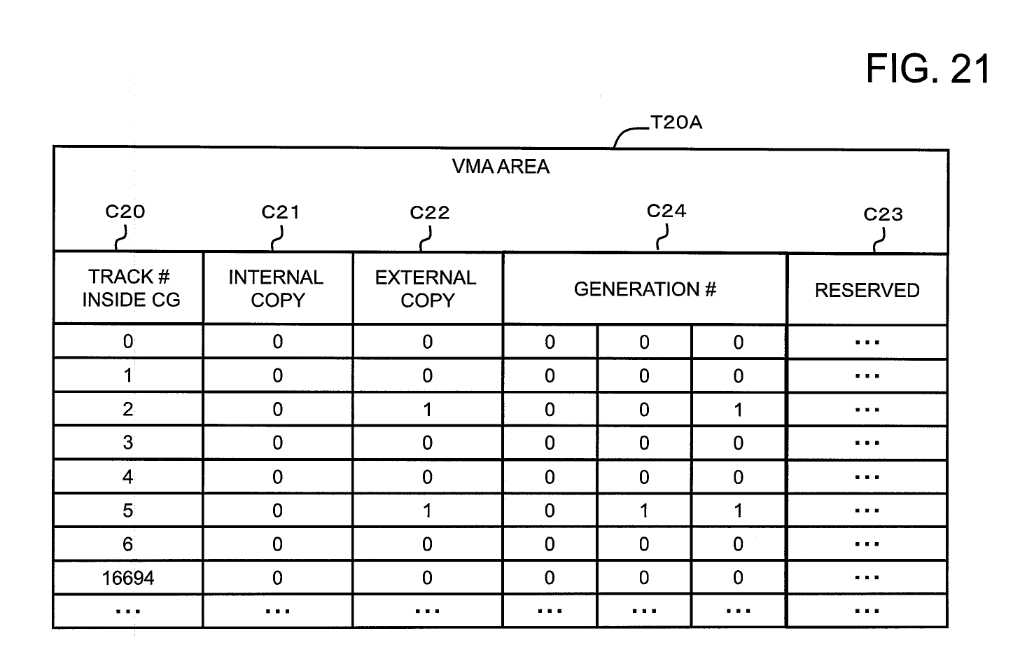

In addition to the copy flags C21 and C22, which denote either an internal copy or an external copy, it is also possible, for example, to store generation management information C24 in the VMA area T20A shown in FIG. 21. The generation management information C24, for example, is used for managing a backup generation of the virtual logical volume 240.

The present invention is not limited to the embodiment described hereinabove. A person with ordinary skill in the art will be able to make various additions and changes within the scope of the present invention.

### REFERENCE SIGNS LIST

1 Storage control apparatus
2 Controller
2A I/O processor
2B Mapping managing unit
2C Allocation controller
2D Copy controller
3 Virtual logical volume
3A Initial allocation area
3B Additional allocation area
4 Pool
5 (1), 5 (2) Storage device
6 Cylinder group
6A User area
6B Control area
7 Host
10 (1), 10 (2) Storage control apparatus
20 (1), 20 (2) Host
30 Management terminal
100 (1), 100 (2) Controller
200 Pool
210 Storage device
220 RAID group
230 Logical volume (real volume)
240 Virtual logical volume
241 User area
242 Control area
300 Cylinder group
310 Page
320 Cylinder
330 Track

1. A storage control apparatus, comprising:
a virtual logical volume, which is a virtually created logical volume and which is accessed from a host computer;
a pool which has a real storage area that is allocated to the virtual logical volume; and
a controller, which controls the allocation of the real storage area to the virtual logical volume, and which relates the real storage area inside the pool to the virtual logical volume in units of a first real storage area that comprises a prescribed first size, and selects a second real storage area that has a prescribed second size from the first real storage area related to the virtual logical volume and allocates same to the virtual logical volume in accordance with a write request from the host computer, wherein
the first size is set to an integral multiple of the second size, and
control information related to a first real storage area concerned is stored in the first real storage area.

2. A storage control apparatus according to claim 1, wherein
the virtual logical volume is coupled to the host computer and to another storage control apparatus via a communication network, and
the host computer is configured as a mainframe,
the controller has: an allocation controller for allocating the first real storage area and the second real storage area to the virtual logical volume; a correspondence managing unit for managing a corresponding relationship between the virtual logical volume, the first real storage area, and the second real storage area; an access request processor for processing an access request from the host computer to the virtual logical volume based on the corresponding relationship managed by the correspondence managing unit; and a copy controller, which creates a copy-pair between the virtual logical volume and another logical volume inside the other storage control apparatus and copies data between the virtual logical volume and the other logical volume,
the first real storage area that is allocated to the virtual logical volume has a user area, which the host computer is able to access via the access request processor, and a control area for storing the control information to be used by the copy controller,
the allocation controller expands a volume size of the virtual logical volume in units of the first real storage area without suspending access to the virtual logical volume from the host computer,
the controller provides to the host computer only the user area of the first real storage area allocated to the virtual logical volume,
the controller, in a case where prescribed data inside the user area is accessed by the host computer, specifies the control information corresponding to the prescribed data based on an access-destination address of the host computer and updates the specified control information, and
the copy controller copies difference data generated in the user area by transferring this difference data to the other logical volume based on the control information stored in the control area.

3. A storage control apparatus according to claim 1, wherein
the control information is stored either at the start or the end of the first real storage area,
another area of the first real storage area besides the area in which the control information is stored is the user area that is able to be used by the host computer, and
the controller provides the host computer with only the user area, enabling access thereto.

4. A storage control apparatus according to claim 3, wherein the controller, in a case where prescribed data of the user area is accessed by the host computer, specifies a location of the control information corresponding to the prescribed data based on the access-destination address of the host computer.

5. A storage control apparatus according to claim 3, wherein the virtual logical volume forms a copy-pair with the other logical volume, and the control information includes copy management information for managing the copy-pair.

6. A storage control apparatus according to claim 5, wherein the copy management information includes information showing a type of the copy-pair.

7. A storage control apparatus according to claim 5, wherein the copy management information includes:
information for managing a difference between the storage content of the virtual logical volume and the storage content of the other logical volume;
internal copy information for showing that the other logical volume and the virtual logical volume are disposed in the same storage control apparatus; and
external copy information for showing that the other logical volume and the virtual logical volume are disposed in different storage control apparatuses.

8. A storage control apparatus according to claim 5, wherein the control information includes a reserved bit prepared for future functional expansion.

9. A storage control apparatus according to claim 1, wherein the virtual logical volume is configured from a real logical volume and the second real storage area that is allocated from the pool.

10. A storage control apparatus according to claim 1, wherein the virtual logical volume is configured only from the second real storage area that is allocated from the pool.

11. A storage control apparatus according to claim 1, wherein the real storage area inside the pool has a RAID configuration.

12. A storage control apparatus according to claim 1, wherein the host computer is a mainframe.

13. A method for controlling a virtual logical volume, which is a virtually created logical volume, the method comprising: in a case where a volume size of the virtual logical volume is expanded,
allocating a real storage area, which is managed in a pool, to the virtual logical volume in units of a first real storage area that has a prescribed first size without suspending access from a host computer;
selecting a second real storage area that has a prescribed second size from the first real storage area allocated to the virtual logical volume and allocating same to the virtual logical volume in accordance with a write request from the host computer;
setting the first size to an integral multiple of the second size;
storing control information related to the first real storage area in this first real storage area; and
providing the host computer with an area, which excludes the control information of the first real storage area, as a user area.
